(19) United States
(12) Patent Application Publication
(10) Pub. No.: US 2025/0106747 A1
(43) Pub. Date: Mar. 27, 2025

(54) CONTROL PLANE SERVICE SELECTION

(71) Applicant: QUALCOMM Incorporated, San Diego, CA (US)

(72) Inventors: Miguel GRIOT, La Jolla, CA (US); Gavin Bernard HORN, La Jolla, CA (US); Soo Bum LEE, San Diego, CA (US)

(21) Appl. No.: 18/600,580

(22) Filed: Mar. 8, 2024

Related U.S. Application Data
(60) Provisional application No. 63/584,841, filed on Sep. 22, 2023.

(51) Int. Cl. H04W 48/18; H04W 12/06; H04W 48/16; H04W 76/20

(52) U.S. Cl. CPC H04W 48/18; H04W 12/06; H04W 48/16; H04W 76/20

(57) ABSTRACT

Various aspects of the present disclosure generally relate to wireless communication. In some aspects, a user equipment (UE) may select a service provided over a control plane. The UE may transmit a message that includes an indication of the service and a UE identifier for the UE. The UE may receive a configuration for the service. Numerous other aspects are described.

### CROSS-REFERENCE TO RELATED APPLICATION

This Patent Application claims priority to U.S. Provisional Patent Application No. 63/584,841, filed on Sep. 22, 2023, entitled “CONTROL PLANE SERVICE SELECTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for control plane services.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

In the early days of the internet, data networks were set up to provide many services over heterogeneous devices. One design principle of a data network model is that the model included a layered system architecture with a simple service interface spanning many applications and transports. The data network model looked like an hourglass with an internet protocol (IP) layer that sits in the middle and allows routing protocols to be placed on top of any type of interface. Different transports or kinds of services can operate on the interface.

With the arrival of cellular radio networks, such as 3G and 4G, the hourglass aspect of the data network model was adopted into a cellular network model. With the introduction of the smart phone, 4G was successful in providing many services. The 4G protocol stack aimed to support the same model as the internet but for a cellular radio network. This involved the separated control plane to manage the data transport for cellular requirements, such as mobility. Separate control and user plane protocol stacks continued the architecture defined for 3G.

As 4G expanded, new features were introduced to expand the capabilities of the system to new use cases and device types. However, it was not possible to deploy new services without upgrading the underlying protocol. There was no simple way to add a service over the control plane, equivalent in simplicity, to enabling new services over IP. The challenge exists with how to enable services to be deployed independently, while using existing protocols as much as possible and allowing UEs to address service directly without relying on intermediate network functions (e.g., non-access stratum (NAS) signaling, radio resource control (RRC) signaling). Furthermore, with the move to 6G, it may not be optimal to define new data collection, positioning, or other protocols in 6G and every succeeding generation (G).

According to various aspects described herein, a new network design may involve moving away from a monolithic set of protocols (e.g., RRC, NAS) with centralized control (e.g., a central unit control plane (CU-CP), an access and mobility function (AMF)) that can make control plane architecture quite inflexible (and involve one massive control plane protocol). This may include providing individual control plane services, such as an authentication and security service, a subscription service, and a policy service, that can be requested individually. Any update to an individual service does not require an update to the whole control plane. For example, a user equipment (UE) may transmit a message with an indication of a service (provided over the control plane) and a UE identifier (ID) to a radio access network (RAN) network entity. The message may include a control plane transport header on a control plane transport layer that is used for forwarding the message to an address for the service. The RAN network entity may determine the address mapped to the service and forward the message to the address. The service entity at the address may transmit a configuration for the service, which is forwarded to the UE. The UE may use the service over the control plane.

By using individually addressable services on the control plane, the UE and the network may use more flexible deployments of services. As a result, updates to the control plane may be quicker and involve less disruption of services. The core network may support a more distributed functionality, where the UE can communicate directly with each functionality (service). The UE to be able to communicate with any service over the control plane, with a control plane transport that is common to and independent of the control plane services. The UE may discover an address to a service while the network hides the network topology. New or enhanced services may be added later without affecting the control plane transport at the UE, the RAN, or intermediate nodes. As a result, updates to the control plane may be quicker and involve less disruption of services. This may also improve the adoption of services on the network and create new revenue streams, while limiting the redefinition of the control plane with future generations.

Some aspects described herein relate to a method of wireless communication performed by a UE. The method may include selecting a service provided over a control plane. The method may include transmitting a message that includes an indication of the service and a UE ID for the UE. The method may include receiving a configuration for the service.

Some aspects described herein relate to a method of wireless communication performed by a first network entity. The method may include receiving, from a UE, a message that includes an indication of a service provided over a control plane and a UE ID for the UE. The method may include forwarding the message to an address for the service based at least in part on the indication of the service.

Some aspects described herein relate to a method of wireless communication performed by a second network entity. The method may include receiving, from a first network entity, service selection information associated with a service. The method may include transmitting, to the first network entity, a service ID associated with the service.

Some aspects described herein relate to a method of wireless communication performed by a network entity. The method may include receiving a message that includes an indication of a service provided over a control plane and a UE ID for a UE. The method may include transmitting a configuration for the service.

Some aspects described herein relate to an apparatus for wireless communication at a UE. The apparatus may include one or more memories and one or more processors coupled to the one or more memories. The one or more processors may be individually or collectively configured to select a service provided over a control plane. The one or more processors may be individually or collectively configured to transmit a message that includes an indication of the service and a UE ID for the UE. The one or more processors may be individually or collectively configured to receive a configuration for the service.

Some aspects described herein relate to an apparatus for wireless communication at a first network entity. The apparatus may include one or more memories and one or more processors coupled to the one or more memories. The one or more processors may be individually or collectively configured to receive, from a UE, a message that includes an indication of a service provided over a control plane and a UE ID for the UE. The one or more processors may be individually or collectively configured to forward the message to an address for the service based at least in part on the indication of the service.

Some aspects described herein relate to an apparatus for wireless communication at a second network entity. The apparatus may include one or more memories and one or more processors coupled to the one or more memories. The one or more processors may be individually or collectively configured to receive, from a first network entity, service selection information associated with a service. The one or more processors may be individually or collectively configured to transmit, to the first network entity, a service ID associated with the service.

Some aspects described herein relate to an apparatus for wireless communication at a network entity. The apparatus may include one or more memories and one or more processors coupled to the one or more memories. The one or more processors may be individually or collectively configured to receive a message that includes an indication of a service provided over a control plane and a UE ID for a UE. The one or more processors may be individually or collectively configured to transmit a configuration for the service.

Some aspects described herein relate to a non-transitory computer-readable medium that stores a set of instructions for wireless communication by a UE. The set of instructions, when executed by one or more processors of the UE, may cause the UE to select a service provided over a control plane. The set of instructions, when executed by one or more processors of the UE, may cause the UE to transmit a message that includes an indication of the service and a UE identifier for the UE. The set of instructions, when executed by one or more processors of the UE, may cause the UE to receive a configuration for the service.

Some aspects described herein relate to a non-transitory computer-readable medium that stores a set of instructions for wireless communication by a first network entity. The set of instructions, when executed by one or more processors of the first network entity, may cause the first network entity to receive, from a UE, a message that includes an indication of a service provided over a control plane and a UE identifier for the UE. The set of instructions, when executed by one or more processors of the first network entity, may cause the first network entity to forward the message to an address for the service based at least in part on the indication of the service.

Some aspects described herein relate to a non-transitory computer-readable medium that stores a set of instructions for wireless communication by a second network entity. The set of instructions, when executed by one or more processors of the second network entity, may cause the second network entity to receive, from a first network entity, service selection information associated with a service. The set of instructions, when executed by one or more processors of the second network entity, may cause the second network entity to transmit, to the first network entity, a service identifier associated with the service.

Some aspects described herein relate to a non-transitory computer-readable medium that stores a set of instructions for wireless communication by a network entity. The set of instructions, when executed by one or more processors of the network entity, may cause the network entity to receive a message that includes an indication of a service provided over a control plane and a UE identifier for a UE. The set of instructions, when executed by one or more processors of the network entity, may cause the network entity to transmit a configuration for the service.

Some aspects described herein relate to an apparatus for wireless communication. The apparatus may include means for selecting a service provided over a control plane. The apparatus may include means for transmitting a message that includes an indication of the service and an identifier for the apparatus. The apparatus may include means for receiving a configuration for the service.

Some aspects described herein relate to an apparatus for wireless communication. The apparatus may include means for receiving, from another apparatus, a message that includes an indication of a service provided over a control plane and an identifier for the other apparatus. The apparatus may include means for forwarding the message to an address for the service based at least in part on the indication of the service.

Some aspects described herein relate to an apparatus for wireless communication. The apparatus may include means for receiving, from a first network entity, service selection information associated with a service. The apparatus may include means for transmitting, to the first network entity, a service identifier associated with the service.

Some aspects described herein relate to an apparatus for wireless communication. The apparatus may include means for receiving a message that includes an indication of a service provided over a control plane and an identifier for another apparatus. The apparatus may include means for transmitting a configuration for the service.

Aspects generally include a method, apparatus, system, computer program product, non-transitory computer-readable medium, user equipment, base station, wireless communication device, network entity, network node, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture.

FIG. 4 is a diagram of an example of a core network configured to provide network slicing.

FIG. 5 is a diagram illustrating an example of a user plane protocol stack and a control plane protocol stack for a network node and a core network in communication with a UE.

FIG. 6 is a diagram illustrating an example of design models.

FIG. 7 is a diagram illustrating an example of a 5G design.

FIG. 8 is a diagram illustrating an example of a new design for networks

FIG. 9 is a flowchart of an example method of wireless communication.

FIG. 10 is a flowchart of an example method of wireless communication.

FIG. 11 is a diagram of an example apparatus for wireless communication.

FIG. 12 is a diagram illustrating an example of a hardware implementation for an apparatus employing a processing system.

FIG. 13 is a diagram of an example apparatus for wireless communication.

FIG. 14 is a diagram illustrating an example of a hardware implementation for an apparatus employing a processing system.

FIG. 15 is a diagram illustrating an example of a new radio (NR) system architecture, in accordance with the present disclosure.

FIG. 16 is a diagram illustrating an example of a network design, in accordance with the present disclosure.

FIG. 17 is a diagram illustrating an example of control plane services, in accordance with the present disclosure.

FIG. 18 is a diagram illustrating an example of a service based architecture, in accordance with the present disclosure.

FIG. 19 is a diagram illustrating an example of a control plane protocol stack, in accordance with the present disclosure.

FIG. 20 is a diagram illustrating an example of a control plane protocol stack, in accordance with the present disclosure.

FIG. 21 is a diagram illustrating an example of a control plane transport flow, in accordance with the present disclosure.

FIG. 22 is a diagram illustrating an example of security context flow, in accordance with the present disclosure.

FIG. 23 is a diagram illustrating an example of service selection, in accordance with the present disclosure.

FIG. 24 is a diagram illustrating an example of service selection, in accordance with the present disclosure.

FIG. 25 is a diagram illustrating an example of service selection, in accordance with the present disclosure.

FIG. 26 is a flowchart of an example method of wireless communication.

FIG. 27 is a flowchart of an example method of wireless communication.

FIG. 28 is a flowchart of an example method of wireless communication.

FIG. 29 is a flowchart of an example method of wireless communication.

FIG. 30 is a diagram of an example apparatus for wireless communication, in accordance with the present disclosure.

FIG. 31 is a diagram illustrating an example of a hardware implementation for an apparatus employing a processing system, in accordance with the present disclosure.

FIG. 32 is a diagram of an example apparatus for wireless communication, in accordance with the present disclosure.

FIG. 33 is a diagram illustrating an example of a hardware implementation for an apparatus employing a processing system, in accordance with the present disclosure.

FIG. 34 is a diagram of an example apparatus for wireless communication, in accordance with the present disclosure.

FIG. 35 is a diagram illustrating an example of a hardware implementation for an apparatus employing a processing system, in accordance with the present disclosure.

FIG. 36 is a diagram of an example apparatus for wireless communication, in accordance with the present disclosure.

FIG. 37 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

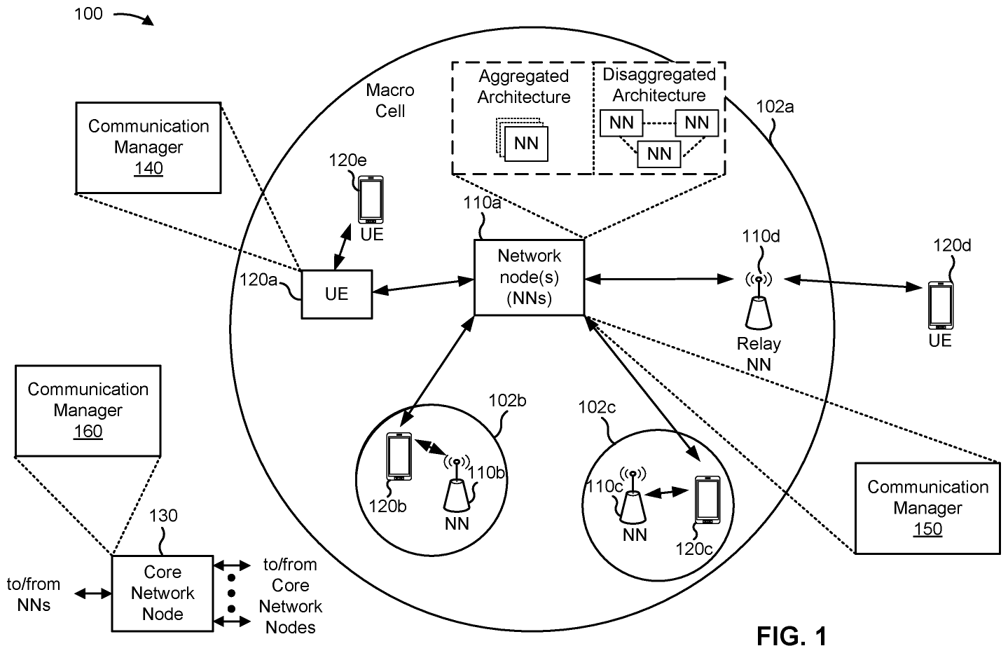

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an 5G base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network. In some examples, a core network node 130 may be a network node that communicates with a RAN node and/or other core network nodes.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller may couple to or communicate with a set of network nodes 110 and may provide coordination and control for these network nodes 110. The network controller may communicate with the network nodes 110 via a backhaul communication link or a midhaul communication link. The network nodes 110 may communicate with one another directly or indirectly via a wireless or wireline backhaul communication link. In some aspects, the network controller may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless communication network 100 may communicate using the electromagnetic spectrum, which may be subdivided by frequency or wavelength into various classes, bands, or channels. For example, devices of the network 100 may communicate using one or more operating bands. In 5G, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., a UE 120) may include a communication manager 140. As described in more detail elsewhere herein, the communication manager 140 may select a service provided over a control plane. The communication manager 140 may transmit a message that includes an indication of the service and a UE identifier (ID) for the UE. The communication manager 140 may receive a configuration for the service. Additionally, or alternatively, the communication manager 140 may perform one or more other operations described herein.

In some aspects, a first network entity (e.g., a network node 110) may include a communication manager 150. As described in more detail elsewhere herein, the communication manager 150 may receive, from a UE, a message that includes an indication of a service provided over a control plane and a UE ID for the UE. The communication manager 150 may forward the message to an address for the service based at least in part on the indication of the service. Additionally, or alternatively, the communication manager 150 may perform one or more other operations described herein.

In some aspects, a second network entity (e.g., a core network node 130) may include a communication manager 160. As described in more detail elsewhere herein, the communication manager 160 may receive, from a first network entity, service selection information associated with a service. The communication manager 160 may transmit, to the first network entity, a service ID associated with the service. Additionally, or alternatively, the communication manager 160 may perform one or more other operations described herein.

In some aspects, a network entity (e.g., a core network node 130) may include a communication manager 160. As described in more detail elsewhere herein, the communication manager 160 may receive a message that includes an indication of a service provided over a control plane and a UE ID for a UE. The communication manager 160 may transmit a configuration for the service. Additionally, or alternatively, the communication manager 160 may perform one or more other operations described herein.

In some aspects, a UE (e.g., a UE 120) may include a communication manager 140. As described in more detail elsewhere herein, the communication manager 140 may select a user plane for a service; transmit a request for a service over a user plane. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive a request for a service over a user plane; and transmit a response indicating that the service is to be over the user plane. Additionally, or alternatively, the communication manager 150 may perform one or more other operations described herein.

As indicated above, FIG. 1 is provided as an example. Other examples may differ from what is described with regard to FIG. 1.

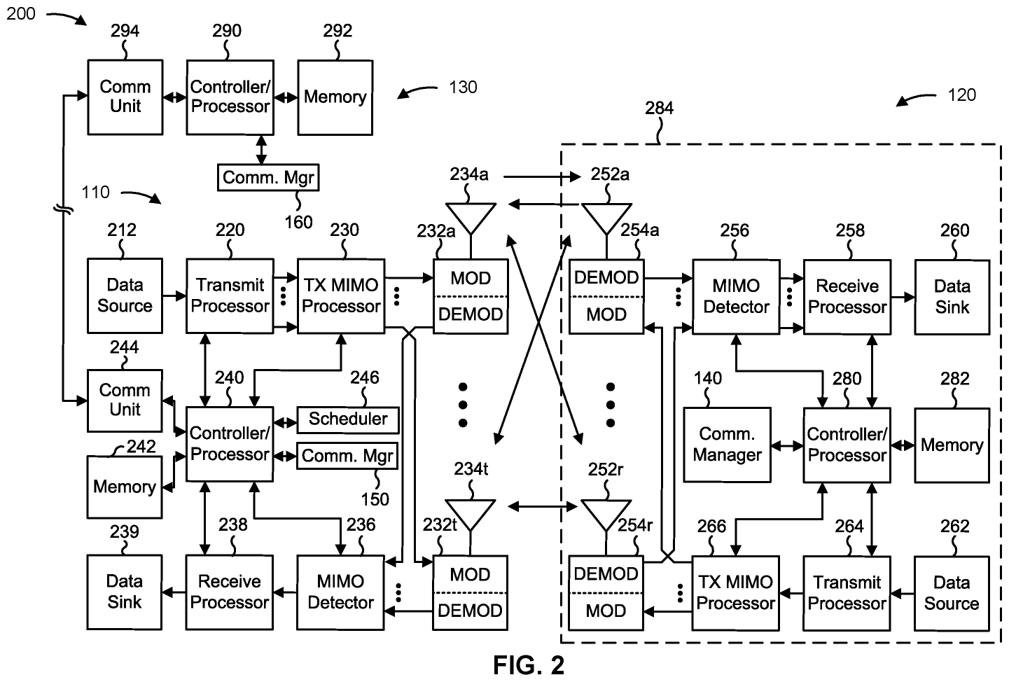

FIG. 2 is a diagram illustrating an example 200 of a network node 110 in communication with a UE 120 in a wireless communication network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller may include a communication unit 294, a controller/processor 290, and a memory 292. The network controller may include, for example, one or more devices in a core network. The network controller may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

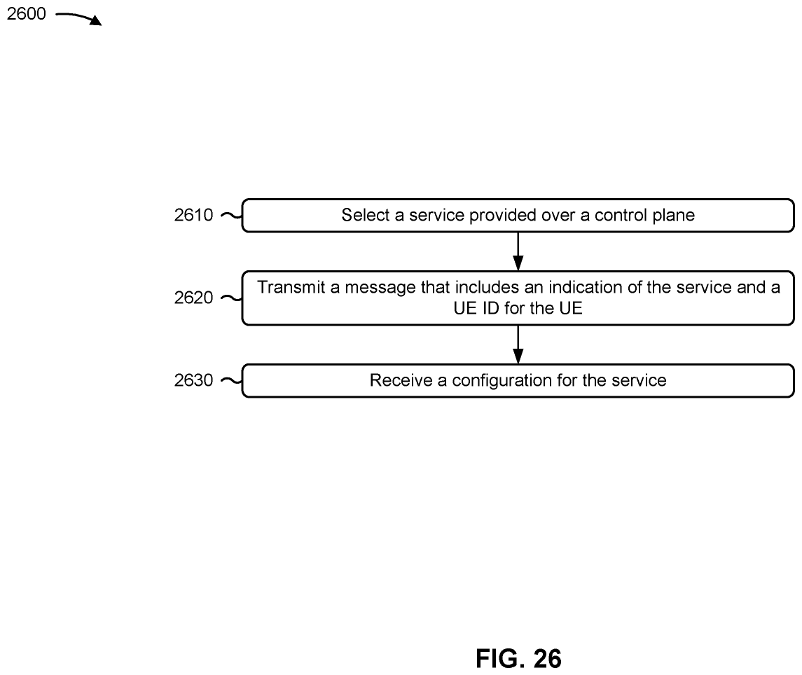

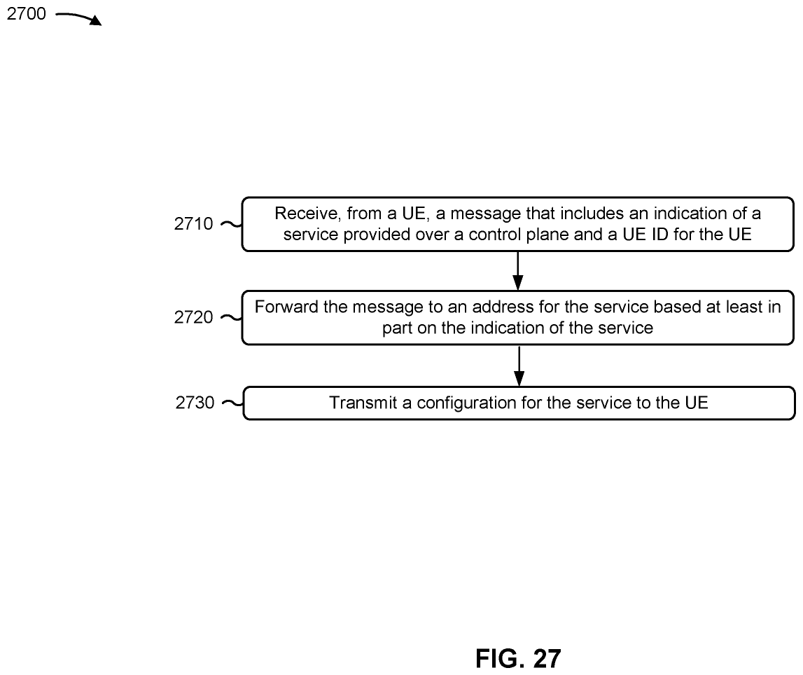

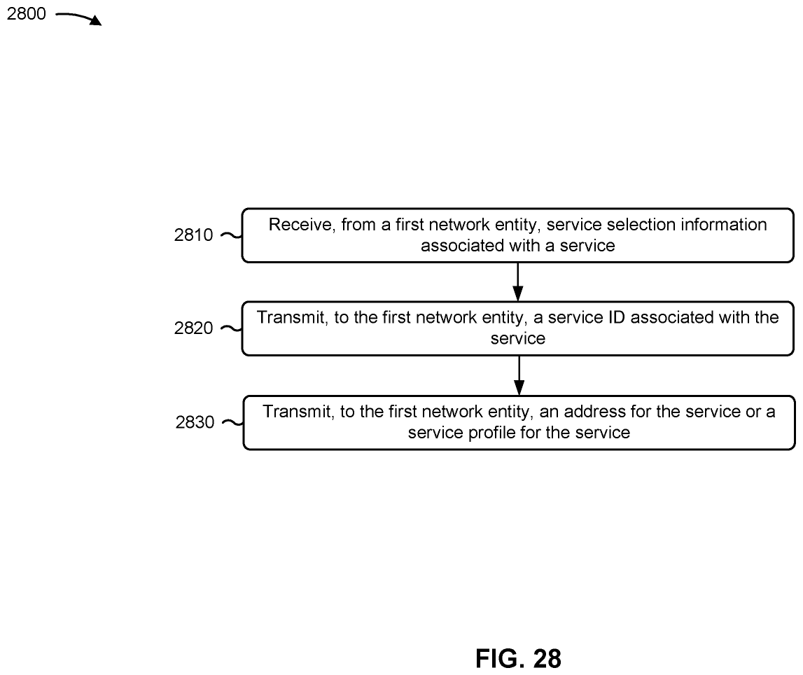

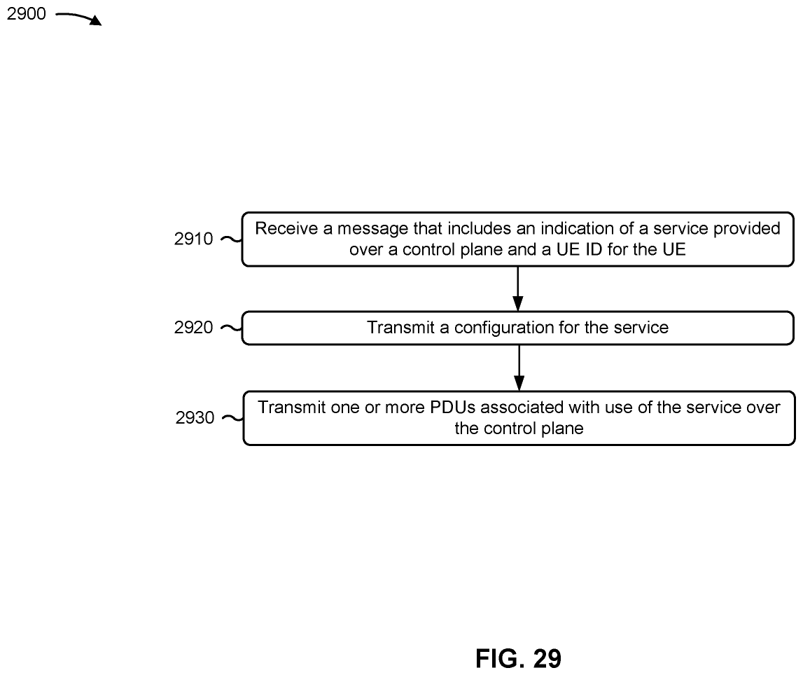

The controller/processor of a network entity (e.g., the controller/processor 240 of the network node 110, the controller/processor 290 of the network node 130), the controller/processor 280 of the UE 120, and/or any other component(s) of FIG. 2 may perform one or more techniques associated with using a service over a user plane, as described in more detail elsewhere herein. For example, the controller/processor 240 of the network node 110, the controller/processor 290 of the network node 130, the controller/processor 280 of the UE 120, and/or any other component(s) of FIG. 2 may perform or direct operations of, for example, method 2600 of FIG. 26, method 2700 of FIG. 27, method 2800 of FIG. 28, method 2900 of FIG. 29, and/or other processes as described herein. The memory 242, the memory 292, and the memory 282 may store data and program codes for the network node 110, the core network node 130, and the UE 120, respectively. In some examples, the memory 242, the memory 292, and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110, the core network node 130, and/or the UE 120, may cause the one or more processors, the UE 120, the core network node 130, and/or the network node 110 to perform or direct operations of, for example, method 2600 of FIG. 26, method 2700 of FIG. 27, method 2800 of FIG. 28, method 2900 of FIG. 29, and/or other processes as described herein. In some examples, executing instructions may include running the instructions, converting the instructions, compiling the instructions, and/or interpreting the instructions, among other examples.

In some aspects, a UE (e.g., a UE 120) includes means for selecting a service provided over a control plane; means for transmitting a message that includes an indication of the service and a UE ID for the UE; and/or means for receiving a configuration for the service. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first network entity (e.g., a network node 110) includes means for receiving, from a UE, a message that includes an indication of a service provided over a control plane and a UE ID for the UE; and/or means for forwarding the message to an address for the service based at least in part on the indication of the service. In some aspects, the means for the first network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a second network entity (e.g., a core network node 130) includes means for receiving, from a first network entity, service selection information associated with a service; and/or means for transmitting, to the first network entity, a service ID associated with the service. In some aspects, the means for the second network entity to perform operations described herein may include, for example, one or more of communication manager 160, controller/processor 290, memory 292, or communication unit 294.

In some aspects, a network entity (e.g., a core network node 130) includes means for receiving a message that includes an indication of a service provided over a control plane and a UE ID for a UE; and/or means for transmitting a configuration for the service. In some aspects, the means for the second network entity to perform operations described herein may include, for example, one or more of communication manager 160, controller/processor 290, memory 292, or communication unit 294.

In some aspects, a UE (e.g., a UE 120) includes means for selecting a user plane for a service; means for transmitting a request for a service over a user plane. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a core network node 130) includes means for receiving a request for a service over a user plane; and/or means for transmitting a response indicating that the service is to be over the user plane. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G systems, may be arranged in multiple manners with various components or constituent parts. In a 5G system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

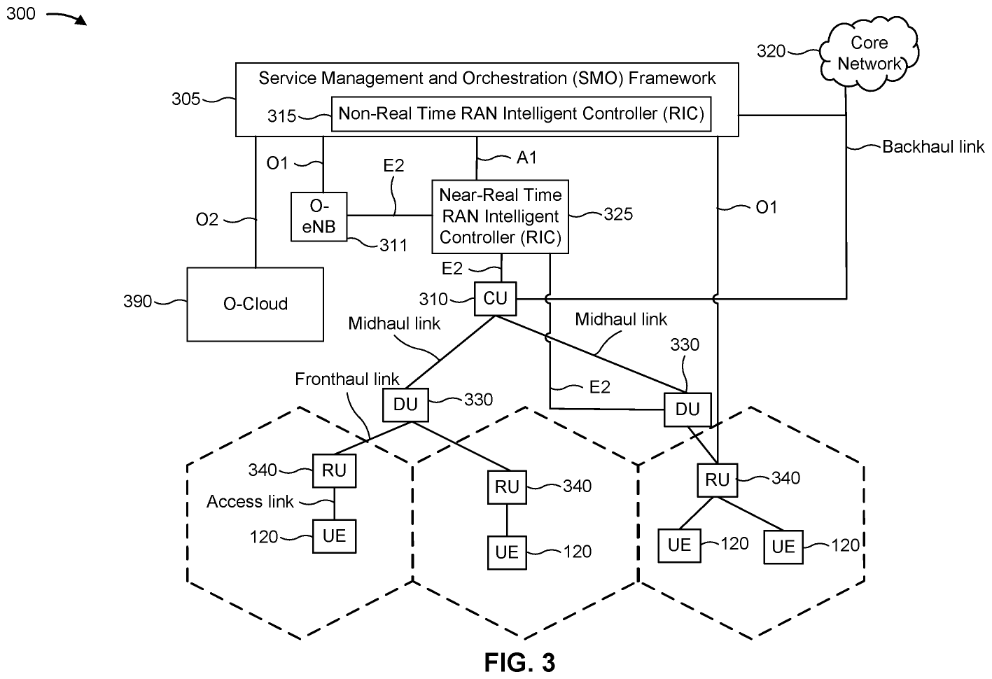

FIG. 3 is a diagram illustrating an example disaggregated base station architecture 300. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

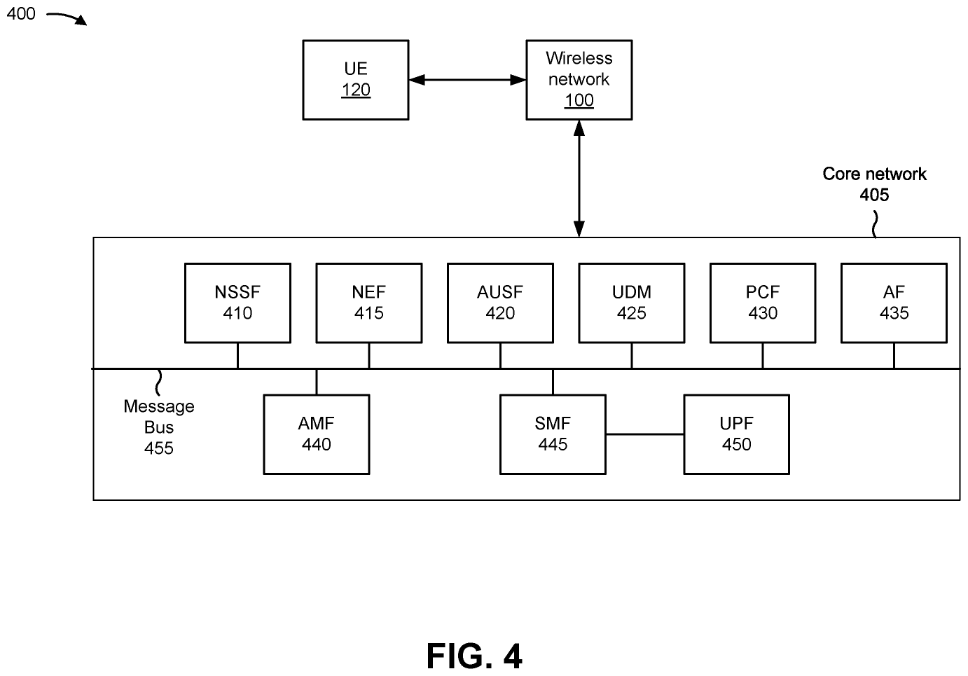

FIG. 4 is a diagram of an example 400 of a core network 405 configured to provide network slicing. As shown in FIG. 4, example 400 may include a UE 120, a wireless communication network 100, and a core network 405. Devices and/or networks of example 400 may interconnect via wired connections, wireless connections, or a combination thereof.

The wireless communication network 100 may support, for example, a cellular RAT. The network 100 may include one or more network nodes, such as base stations (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network nodes that can support wireless communication for the UE 120. The network 100 may transfer traffic between the UE 120 (e.g., using a cellular RAT), one or more network nodes (e.g., using a wireless interface or a backhaul interface, such as a wired backhaul interface), and/or the core network 405. The network 100 may provide one or more cells that cover geographic areas.

In some aspects, the wireless communication network 100 may perform scheduling and/or resource management for the UE 120 covered by the network 100 (e.g., the UE 120 covered by a cell provided by the network 100). In some aspects, the network 100 may be controlled or coordinated by a network controller, which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 405 may include an example functional architecture in which systems and/or methods described herein may be implemented. For example, the core network 405 may include an example architecture of a fifth generation (5G) next generation (NG) core network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of functional elements. The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, a session management function (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 410 may determine a set of network slice policies to be applied at the wireless communication network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for NAS signaling and/or mobility management, among other examples. In some aspects, the AMF may request the NSSF 410 to select network slice instances for the UE 120, e.g., at least partially in response to a request for data service from the UE 120.

The SMF 445 may include one or more devices that support the establishment, modification, and release of communication sessions in the wireless telecommunications system. For example, the SMF 445 may configure traffic steering policies at the UPF 450 and/or enforce UE internet protocol (IP) address allocation and policies, among other examples. In some aspects, the SMF 445 may provision the network slice instances selected by the NSSF 410 for the UE 120.

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane quality of service (QoS), among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

While FIG. 4 describes elements of a 5G network, such elements may be included in a 6G network and beyond.

As indicated above, FIG. 4 is provided as an example. Other examples may differ from what is described with regard to FIG. 4.

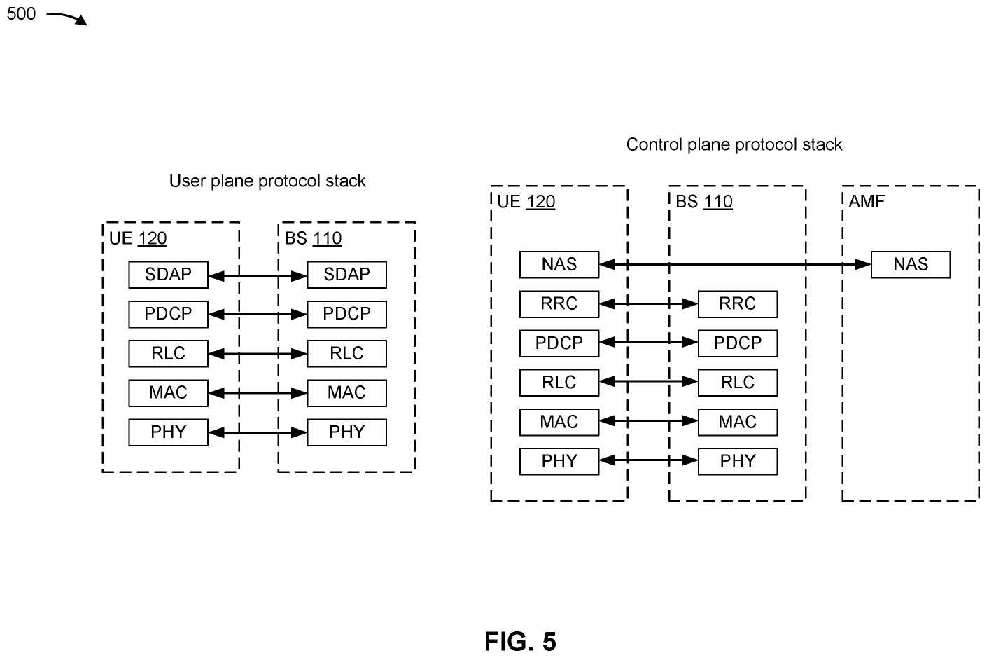

FIG. 5 is a diagram illustrating an example 500 of a user plane protocol stack and a control plane protocol stack for a network node 110 and a core network in communication with a UE 120.

In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective PHY layers, MAC layers, RLC layers, PDCP layers, and SDAP layers. A user plane function may handle transport of user data between the UE 120 and the network node 110. On the control plane, the UE 120 and the network node 110 may include respective RRC layers. Furthermore, the UE 120 may include an NAS layer in communication with an NAS layer of an AMF. The AMF may be associated with a core network associated with the network node 110, such as a 5G core network (5GC), a 6G core network, or an NG-RAN. A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 5, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); QoS management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 5 is provided as an example. Other examples may differ from what is described with regard to FIG. 5.

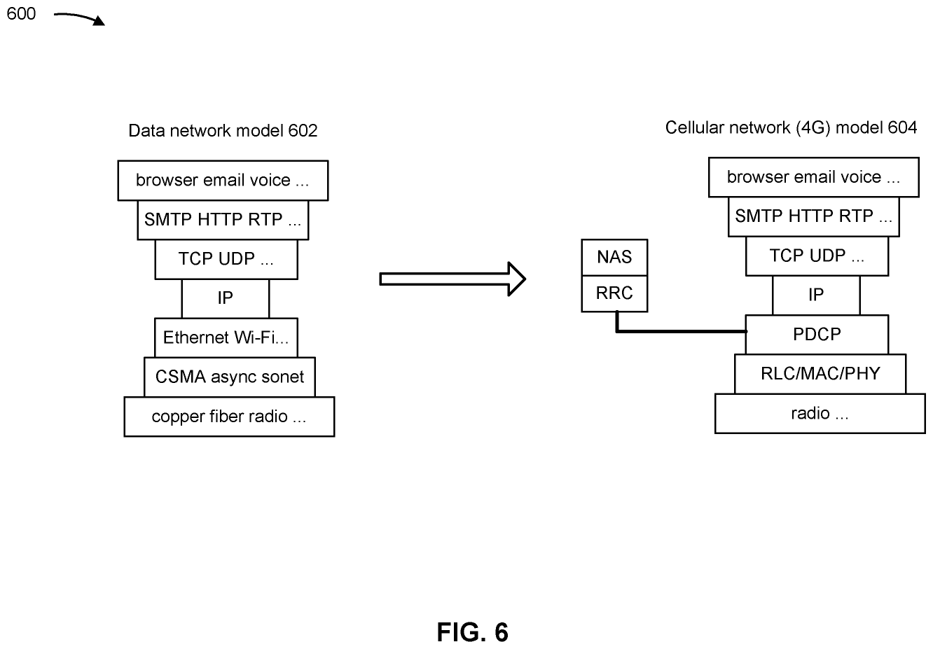

FIG. 6 is a diagram illustrating an example 600 of design models.

In the early days of the internet, data networks were set up to provide many services over heterogeneous devices. One design principle, shown by data network model 602, included a layered system architecture with a simple service interface spanning many applications and transports. The data network model 602 looked like an hourglass with an IP layer that sits in the middle and allows routing protocols to be placed on top of any type of interface. Different transports or kinds of services can operate on the interface.

With the arrival of cellular radio networks, such as 3G and 4G, the hourglass aspect of the data network model 602 was adopted, as shown by cellular network model 604. With the introduction of the smart phone, 4G was successful in providing many services. The 4G protocol stack aimed to support the same model as the internet but for a cellular radio network. This involved the separated control plane to manage the data transport for cellular requirements, such as mobility. Separate control and user plane protocol stacks continued the architecture defined for 3G.

As 4G expanded new features were introduced to expand capabilities of the system to new use case and device types. This included expansion both horizontally (carrier aggregation (CA), dual connectivity (DC), etc.) and vertically (IoT, V2X, etc.). 4G success helped spur the expectations for 5G verticals. Additionally, services were introduced to the protocol stack as part of the NAS/RRC protocols. NAS protocol services included location. RRC protocol services included data collection, such a minimization of drive tests (MDT). Additional services provided by NAS and/or RRC, in addition to data transport and connectivity, include positioning, sensing, timing, AI/ML, etc. Service adoption of these NAS/RRC services was limited. It was not possible to deploy new services without upgrading the underlying protocol. There was no simple way to add a service over the control plane equivalent in simplicity to enabling new services over IP.

As indicated above, FIG. 6 is provided as an example. Other examples may differ from what is described with regard to FIG. 6.

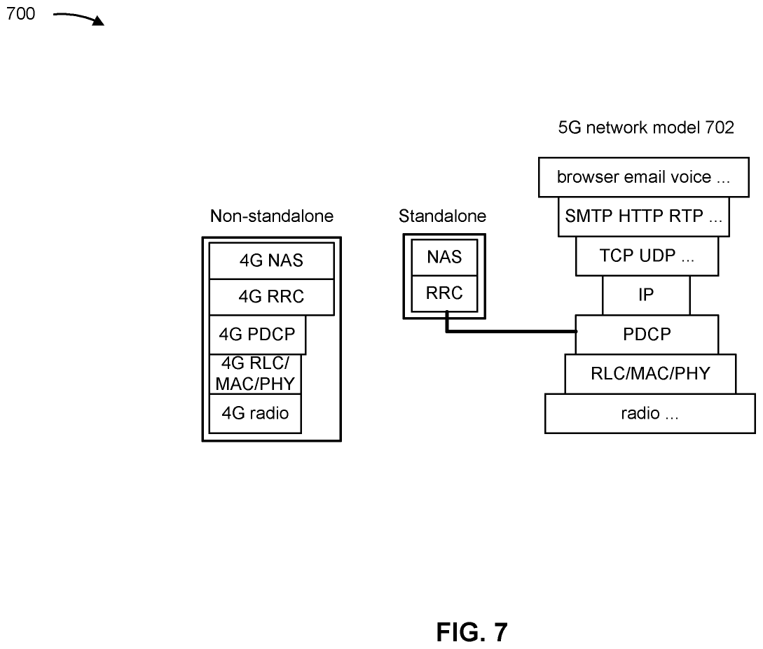

FIG. 7 is a diagram illustrating an example 700 of a 5G design.

Example 700 shows a 5G network model 702 that may be a standalone deployment or a non-standalone deployment that involve 4G. However, the 5G NAS/RRC protocol stack may have been even more monolithic than in 4G. NAS/RRC continues to grow to support even more features such as Industrial IoT, satellites, etc. Service revenue has concentrated in the user plane as support for traditional services continued from the 4G era. History further suggests limited adoption of control plane services. There have been differentiated services built on network slices as a potential feature to drive 5G standalone deployments. Policy and charging functions allow new revenue streams beyond data consumption.

The challenge exists with how to enable services to be deployed independently, while using existing protocols as much as possible and allowing UEs to address service directly without relying on intermediate network functions (e.g., NAS signaling, RRC signaling). Furthermore, with the move to 6G, it may not be optimal to define new data collection, positioning, or other protocols in 6G and every succeeding G.

As indicated above, FIG. 7 is provided as an example. Other examples may differ from what is described with regard to FIG. 7.

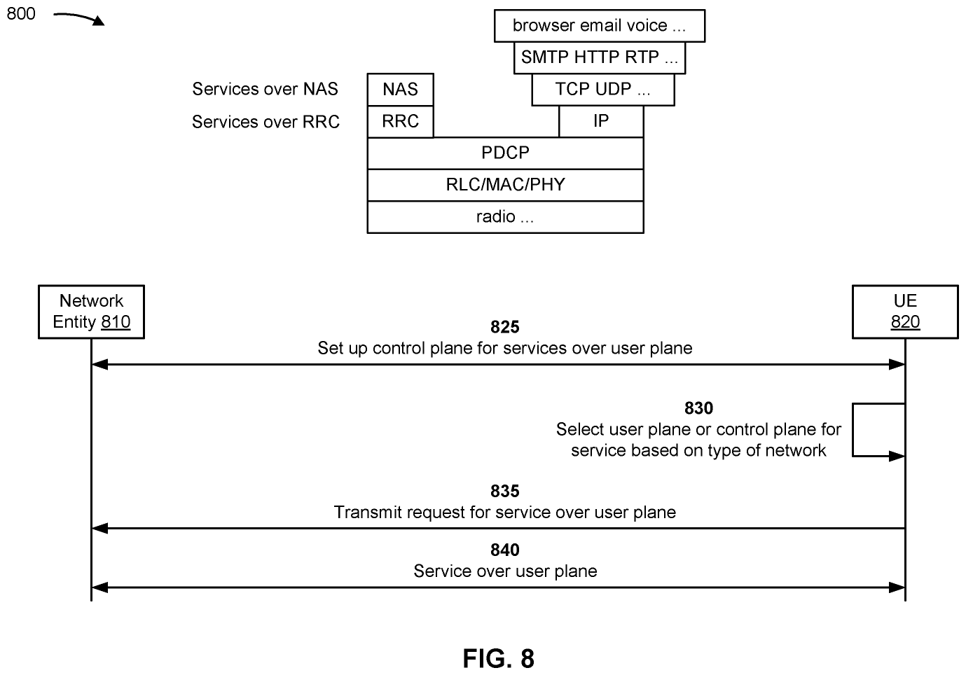

FIG. 8 is a diagram illustrating an example 800 of a new design for networks. As shown in FIG. 8, a network entity 810 (e.g., network node 110) and a UE 820 (e.g., a UE 120) may communicate with one another via a wireless network (e.g., including element of wireless communication network 100). The network may be a 5G network, a 6G network, a later generation network, or a combination of such networks.

In some aspects, a new network design may involve moving away from defining a G-specific control plane for every G and enabling the hourglass model on the control plane. This may include defining what is hosted in the control plane in a user plane first approach. A thinner control plane for 6G may make control plane services available in 5G and other RATs. Control plane services, including location and data collection, may be available (e.g., upon an address request) over the user plane and may become G-independent using standardized APIs. Services address and executed over the user plane may include a data session, a PDU session, a sensing service, a location service, a policy service, UE device management, and/or a policy download on the UE.

The new design may leverage the scale of internet services and protocols to enable many potential vendors for these services instead of the restricted few infra vendors today. The new design may include simplify how remaining services are enabled over NAS and RRC. The control plane may not be G-specific, and NAS and RRC may be defined just as a transport layer for services. Services may be decoupled from the transport. For example, a service interface may be enabled such that connectivity, session management, and other services are built on top of NAS and RRC instead of incorporated in the NAS protocol.

In some aspects, the NAS layer may be common across services. The NAS layer may provide for service discovery, routing, and late binding. The transport layer may be at the service entry point. The same transport layer may be used for both the user plane and the control plane with no differences from a protocol standpoint. Services may be differentiated via a service ID. Reliability and security may be implemented at the transport/service layer or relocated per service requirements. Microservices behind the service entry point may be transparent to other parts of the system (e.g., including the UE). In some aspects, the UE may use a service ID, a NAS ID, a paging ID, and/or a RAN ID. The UE may use such IDs to address a service directly over the user plane. The NAS/RRC layer may be used for authentication, some mobility services, and for setting up the user plane.

By using the NAS protocol and RRC signaling as a transport/service layer to set up services that operate on the user plane, the adoption of services on the network may expand and create new revenue streams, while limiting the redefinition of the control plane with future generations.

Example 800 shows an example of the UE 820 requesting a service over a user plane. At 825, the network entity 810 and the UE 820 may set up a control plane (e.g., NAS protocols, RRC signaling) for services over a user plane. This may include setting up a NAS/RRC layer to operate as a transport for services that may have been handled by the control plane in earlier networks. The setup of the control plane may involve authentication of the UE 820 for requesting services.

In some aspects, at 830, the UE 820 may select to use the user plane or the control plane to request a service based at least in part on a type of network. For example, the UE 820 may select the user plane if the network is 6G, or select the control plane if the network is 5G. Selection between the user plane or control plane may be based on the G (6G+vs. 3G/4G/5G) of the network connection. Selection between the user plane or control plane may be based at least in part on a service or service type. Selection between the user plane or control plane may be based at least in part on a UE configuration, a user preference, or service availability. The service may be the type of service that would have normally been handled by the control plane, such as MDT or managing a QoS. The service may be the type of service that uses a signaling radio bearer in 5G. A service protocol may not be affected by whether the transport is over a control plane or the user plane.

In some aspects, the control plane may be a thinner control plane that provides less service and those services are provided on the user plane. That is, some services of the control plane may be replaced with services on the user plane. A thinner control plane for 6G may have fewer protocols or signaling than used for 5G.

At 835, if the UE 820 selects the user plane, the UE 820 may transmit a request for the service over the user plane. This may include addressing the service using a user plane address. This may include using a service ID, a RAN ID, and/or a NAS ID. At 840, the UE 820 may execute the service over the user plane.

In some aspects, the UE 820 may use a specific PDU session and/or dedicated physical resource blocks (PRBs) that provide for a higher priority on the user plane so as to not increase latency over what is expected for the control plane.

As indicated above, FIG. 8 is provided as an example. Other examples may differ from what is described with respect to FIG. 8.

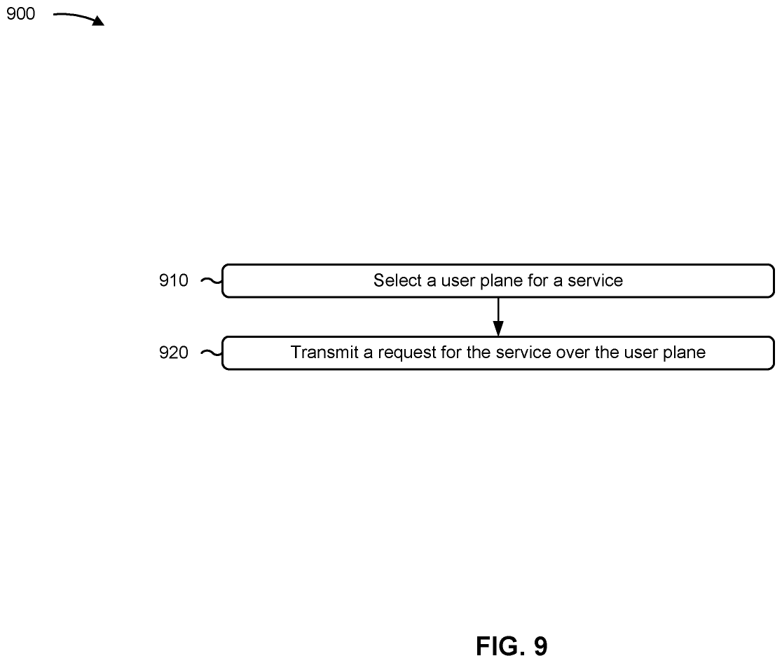

FIG. 9 is a flowchart of an example method 900 of wireless communication. The method 900 may be performed at, for example, a UE (e.g., UE 120, UE 820) or an apparatus of a UE.

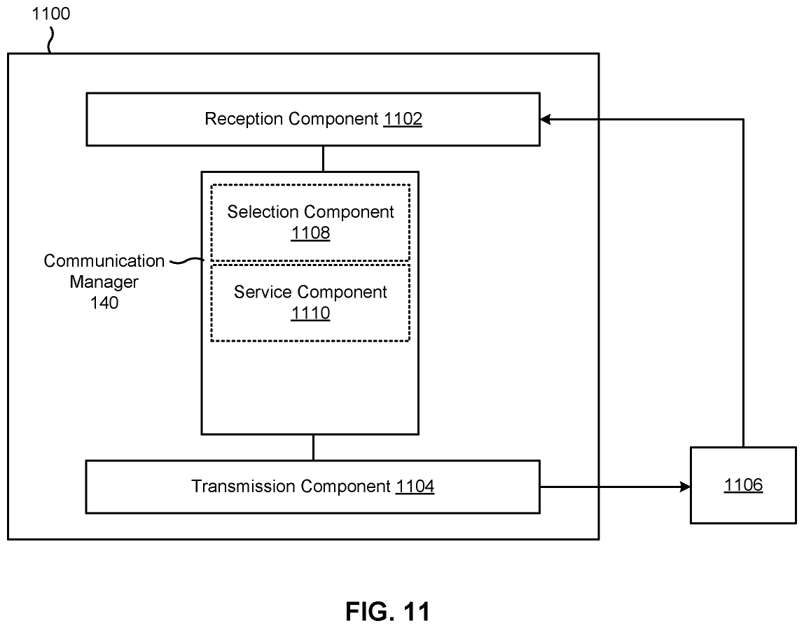

At 910, the UE may select a user plane for a service. For example, the UE (e.g., using communication manager 140 and/or selection component 1108, depicted in FIG. 11) may select a user plane for a service, as described above in connection with, for example, FIGS. 5 and 8.

At 920, the UE may transmit a request for the service over the user plane. For example, the UE (e.g., using communication manager 140 and/or transmission component 1104, depicted in FIG. 11) may transmit a request for the service over the user plane, as described above in connection with, for example, FIG. 5 and at 8.

In some aspects, the selecting the user plane includes selecting between the user plane and a control plane. In some aspects, selecting the user plane includes selecting between the user plane and a control plane based at least in part on a generation of a network connection. In some aspects,

In some aspects, method 900 includes using the service over the user plane. A service protocol may not be affected by whether the transport is over a control plane or the user plane.

In some aspects, the service over the user plane uses a protocol data unit session specific to the service being over the user plane. In some aspects, the service over the user plane uses frequency resources that are specific to the service being over the user plane and having a priority associated with the service being over the user plane. In some aspects, the service over the user plane includes a quality of service management service. In some aspects, the service over the user plane includes a mobility service. In some aspects, the service over the user plane includes a minimization of drive test service. In some aspects, the service over the user plane includes a routing service. In some aspects, the service over the user plane includes a service associated with a connection between the UE and an access and mobility function in a core network.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

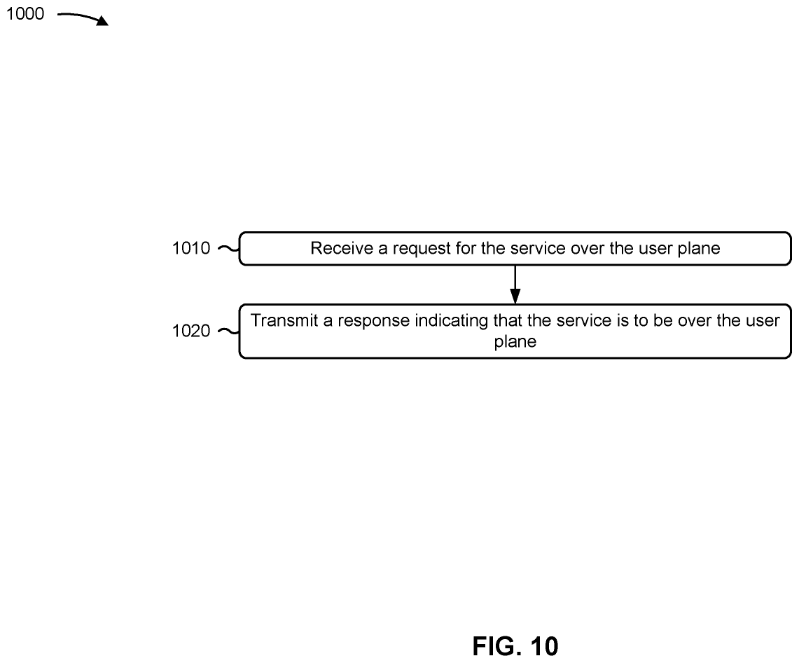

FIG. 10 is a flowchart of an example method 1000 of wireless communication. The method 1000 may be performed at, for example, a network entity (e.g., network node 110, network entity 810) or an apparatus of a network entity.

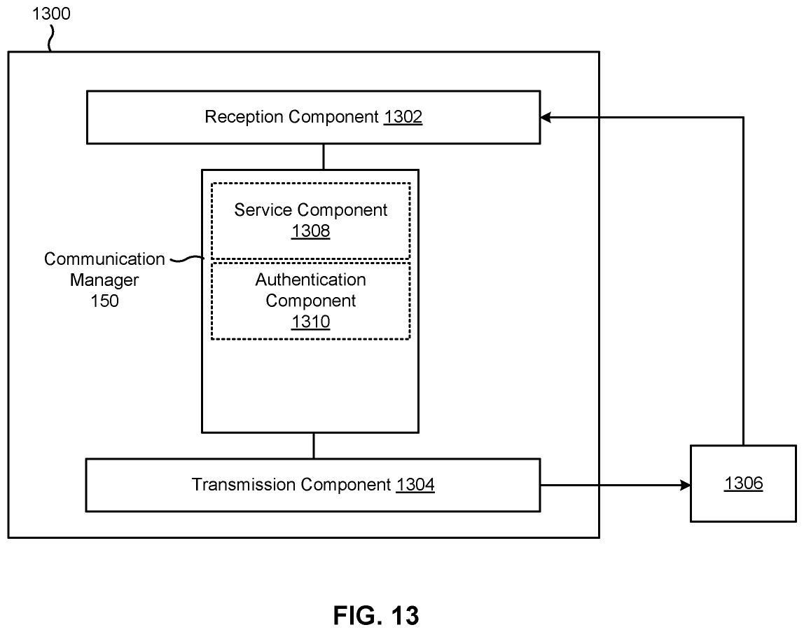

At 1010, the network entity may receive a request for the service over the user plane. For example, the network entity (e.g., using communication manager 150 and/or reception component 1302, depicted in FIG. 13) may receive a request for the service over the user plane, as described above in connection with, for example, FIG. 5 and at 8.

At 1020, the network entity may transmit a response indicating that the service is to be over the user plane. For example, the network entity (e.g., using communication manager 150 and/or transmission component 1304, depicted in FIG. 13) may transmit a response indicating that the service is to be over the user plane, as described above in connection with, for example, FIG. 5 and at 8.

In some aspects, the service is decoupled from a transport layer. In some aspects, method 1000 includes authenticating the service using a control plane, and assisting the operation of the service over the user plane.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may a selection component 1108 and/or a service component 1110, among other examples.

In some aspects, the apparatus 1100 may be configured to perform one or more operations described herein in connection with FIGS. 1-8. Additionally, or alternatively, the apparatus 1100 may be configured to perform one or more processes described herein, such as method 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The selection component 1108 may select a user plane for a service. The transmission component 1104 may transmit a request for the service over the user plane. The service component 1110 may use the service over the user plane.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

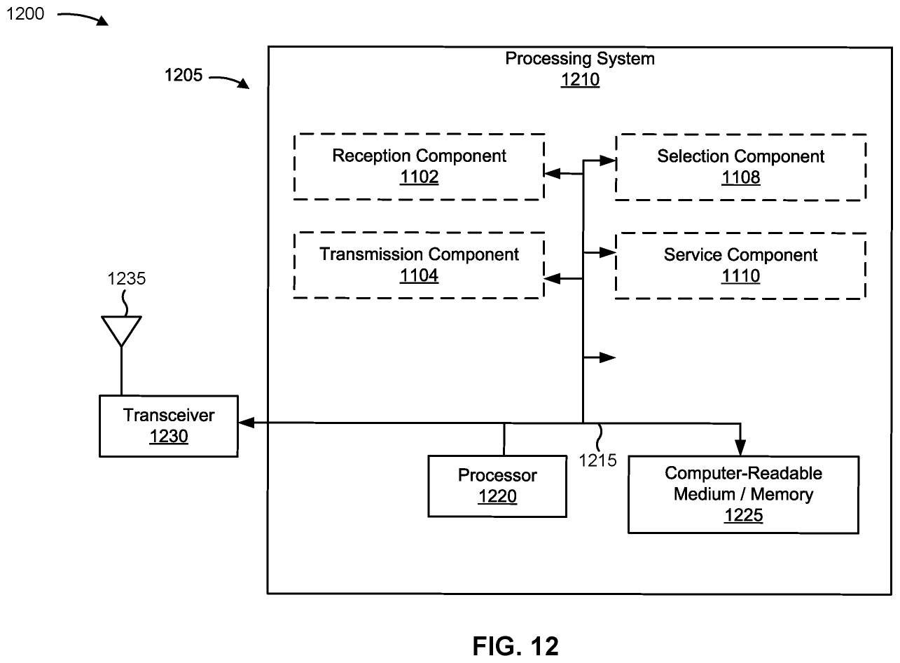

FIG. 12 is a diagram illustrating an example 1200 of a hardware implementation for an apparatus 1205 employing a processing system 1210. The apparatus 1205 may be a UE or may be at (e.g., included in) a UE.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor 1220, the illustrated components, and the computer-readable medium/memory 1225. The bus 1215 may also link various other circuits, such as timing sources, peripherals, voltage regulators, and/or power management circuits.

The processing system 1210 may be coupled to one or more transceivers 1230. A transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes one or more processors 1220 coupled to a computer-readable medium/memory 1225. A processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 maybe a component of the UE 120 and may include one or more memories, such as the memory 282, and/or may include one or more processors, such as at least one of the TX MIMO processor 266, the RX processor 258, and/or the controller/processor 280. In some aspects, the apparatus 1205 for wireless communication includes means for selecting a user plane for a service and means for transmitting a request for the service over the user plane. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 12 is provided as an example. Other examples may differ from what is described in connection with FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a service component 1308 and/or an authentication component 1310, among other examples.

In some aspects, the apparatus 1300 may be configured to perform one or more operations described herein in connection with FIGS. 1-8. Additionally, or alternatively, the apparatus 1300 may be configured to perform one or more processes described herein, such as method 1000 of FIG. 10. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1304 may be co-located with the reception component 1302 in one or more transceivers.

The reception component 1302 may receive a request for the service over the user plane. The transmission component 1304 may transmit a response indicating that the service is to be over the user plane.

The service component 1308 may support the service over the user plane, where the service is decoupled from a transport layer. The authentication component 1310 may authenticate the service using a control plane. The service component 1308 may assist the operation of the service over the user plane.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

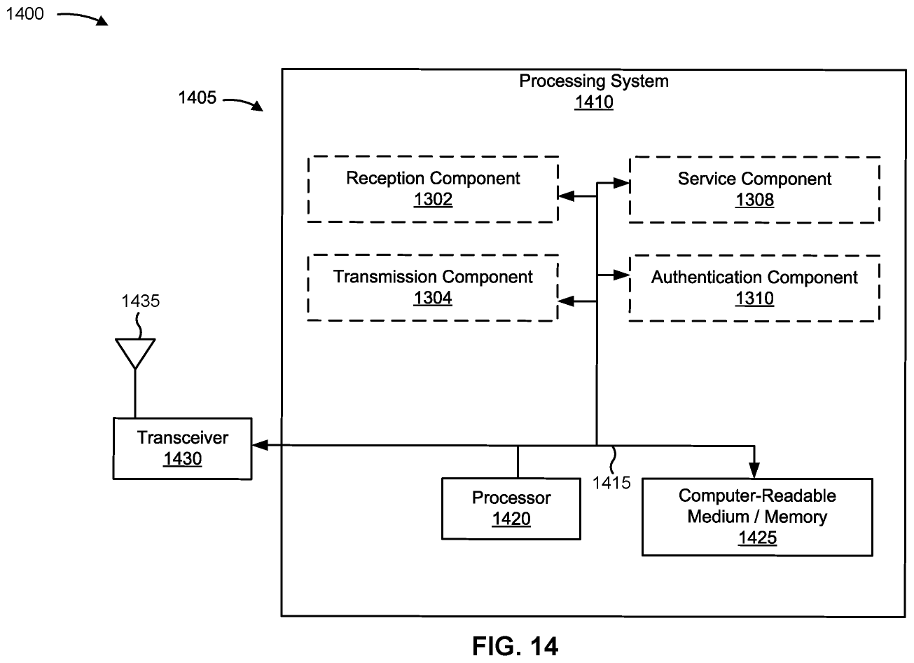

FIG. 14 is a diagram illustrating an example 1400 of a hardware implementation for an apparatus 1405 employing a processing system 1410. The apparatus 1405 may be a network entity or may be at (e.g., included in) a network entity.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to one or more transceivers 1430. A transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes one or more processors 1420 coupled to a computer-readable medium/memory 1425. A processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 maybe a component of the network node 110 and may include one or more memories, such as the memory 242, and/or may include one or more processors, such as at least one of the TX MIMO processor 230, the RX processor 238, and/or the controller/processor 240. In some aspects, the apparatus 1405 for wireless communication includes means for receiving a request for the service over the user plane and means for transmitting a response indicating that the service is to be over the user plane. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 14 is provided as an example. Other examples may differ from what is described in connection with FIG. 14.

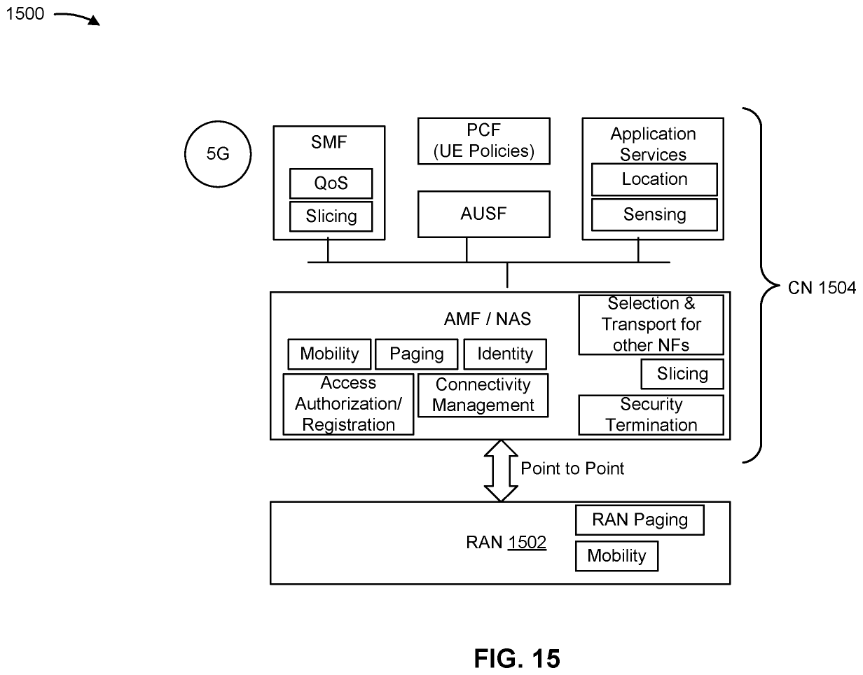

FIG. 15 is a diagram illustrating an example 1500 of an NR system architecture, in accordance with the present disclosure.

Example 1500 shows an NR architecture for 5G. The NR architecture may include a RAN 1502 and network functions in a core network 1504. The RAN 1502 may perform RAN paging or mobility functions. The core network 1504 may include an AMF that uses NAS protocols to provide functions for a UE. The functions may include: mobility; paging; identity; access, authorization, and registration; connectivity management; selection and transport; slicing; and security termination. Application services over the control plane may include SMF services (e.g., QoS, slicing), PCF services, AUSF services, location services, and sensing services. Each of these services have an arbitrary interdependency on the AMF. That is, all core network functions depend on the AMF. Also, the mobility management layer is involved in slicing management, which is a service concept and thus an inefficient split of network functionalities. There is also repeated functionality in the RAN and the core network. All of these services in the control plane involve single vendor deployments that are hard to extend beyond the first release.

In addition, there is only one control plane path between the RAN 1502 and the core network 1504. This forces the architecture to add functionality into the AMF that is not actually relevant to access and mobility management. This single control plane path also creates interdependencies between the AMF and the RAN 1502. A single monolithic set of protocols at the control plane (e.g., NAS protocols, RRC protocols) with centralized control (e.g., a CU-CP, an AMF) makes the network design less flexible to add new features.

As indicated above, FIG. 15 is provided as an example. Other examples may differ from what is described with regard to FIG. 15.

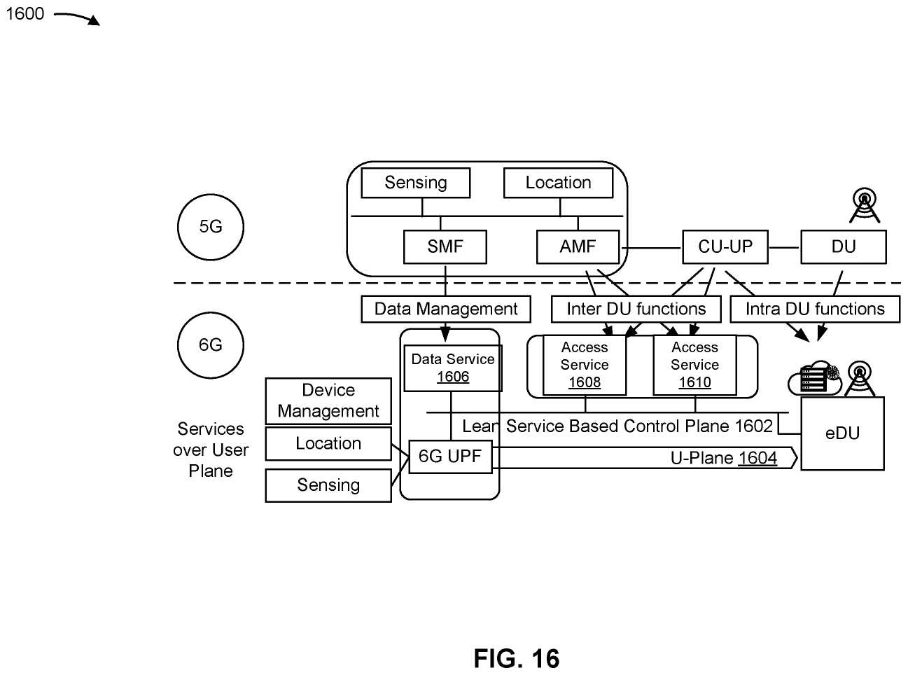

FIG. 16 is a diagram illustrating an example 1600 of a network design, in accordance with the present disclosure.

According to various aspects described herein, a new network design may involve moving away from a monolithic set of protocols with centralized control. This may include providing individual, modular control plane services (functionalities), such as an authentication and security service, a subscription service, and a policy service, that can be requested individually. Any update to an individual service does not require an update to the whole control plane. For example, a UE may transmit a message with an indication of a service (provided over the control plane) and a UE ID to a radio access network (RAN) network entity. The message may include a control plane transport header on a control plane transport layer that is used for forwarding the message to an address for the service. The RAN network entity may determine the address mapped to the service and forward the message to the address. The service entity at the address may transmit a configuration for the service, which is forwarded to the UE. The UE may use the service over the control plane. In some aspects, the core network may provide a discovery and selection service for locating the addresses for services.

By using individually addressable services on the control plane, the UE and the core network may use more flexible deployments of services and features. The core network may support a more distributed functionality, where the UE can communicate directly with each functionality (service). The UE to be able to communicate with any service over the control plane, with a control plane transport that is common to and independent of the control plane services. The UE may discover an address to a service while the network hides the network topology. New or enhanced services may be added later without affecting the control plane transport at the RAN or intermediate nodes. As a result, updates to the control plane may be quicker and involve less disruption of services. This may also improve the adoption of services on the network and create new revenue streams, while limiting the redefinition of the control plane with future generations.

Example 1600 shows an example network design with an end-to-end system architecture for future generations, such as 6G. The network design shows modular control plane protocols with a cloud native service based architecture. A lean, service-based control plane 1602 may provide individual access services 1606, 1608, and 1610 normally provided by the AMF. Some services, such as device management, location, sensing, and data service may be provided over the control plane 1602 or the user plane 1604.

The new design may involve modularization and RAN/core network convergence. Network functionality may be modularized into self-contained service modules. The functionality of the RAN and the core network may converge. The NAS protocols and the UE contexts may be modular. The leaner control plane may be focused on access, connectivity, mobility, and data services. Non-connectivity services may be moved to the user plane.

This new design may allow for an inter-vendor and intra-vendor network functionality split. The new design may enable the faster and easier adoption of new verticals. The new design may allow for forward compatibility to evolved and new features with minimum network impact.

As indicated above, FIG. 16 is provided as an example. Other examples may differ from what is described with regard to FIG. 16.

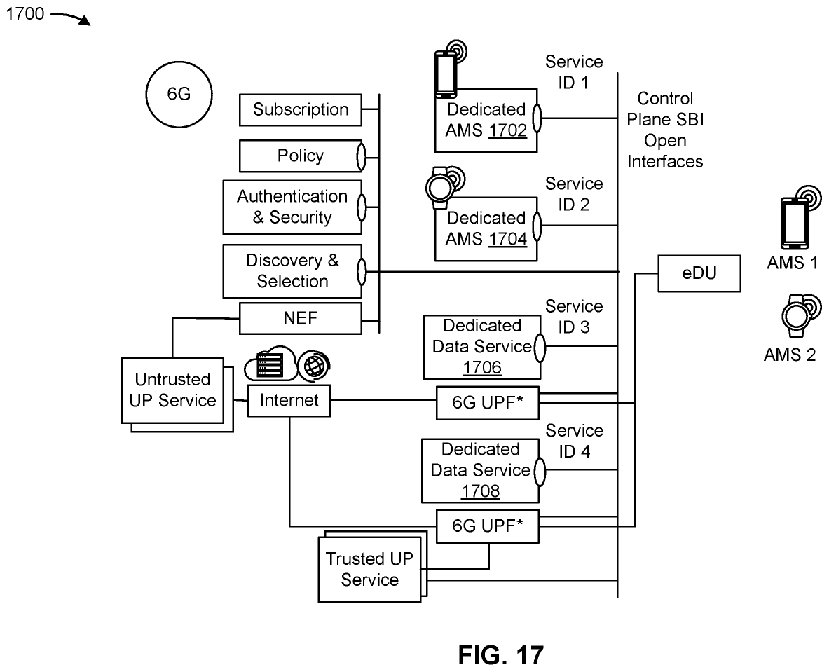

FIG. 17 is a diagram illustrating an example 1700 of control plane services, in accordance with the present disclosure.

Example 1700 shows that dedicated services may be addressable by service ID. Control plane services may include, for example, subscription, policy, authentication and security, discovery and selection, and an NEF. Control plane services may also include a different access and mobility service (AMS) for specific types of devices (e.g., RedCap. IoT, smartphone). Different vendors may provide specialized solutions. In some aspects, these dedicated AMS services may each be identified by a service ID. For example, AMS service 1702 may be identified by service ID 1, and AMS service 1704 may be identified by service ID 2.

User plane services may include dedicated data services, each identified by a service ID. Multiple data service slices (DSSs) per UE may be possible. A DSS may interact directly with the UE and a DU (e.g., eDU). A DSS may interact with an AMS (e.g., for mobility area, paging). A DSS may interact with an authentication and security service to derive its own security context. DSS 1706 may be identified by service ID 3, and DSS 1708 may be identified by service ID 4.

As indicated above, FIG. 17 is provided as an example. Other examples may differ from what is described with regard to FIG. 17.

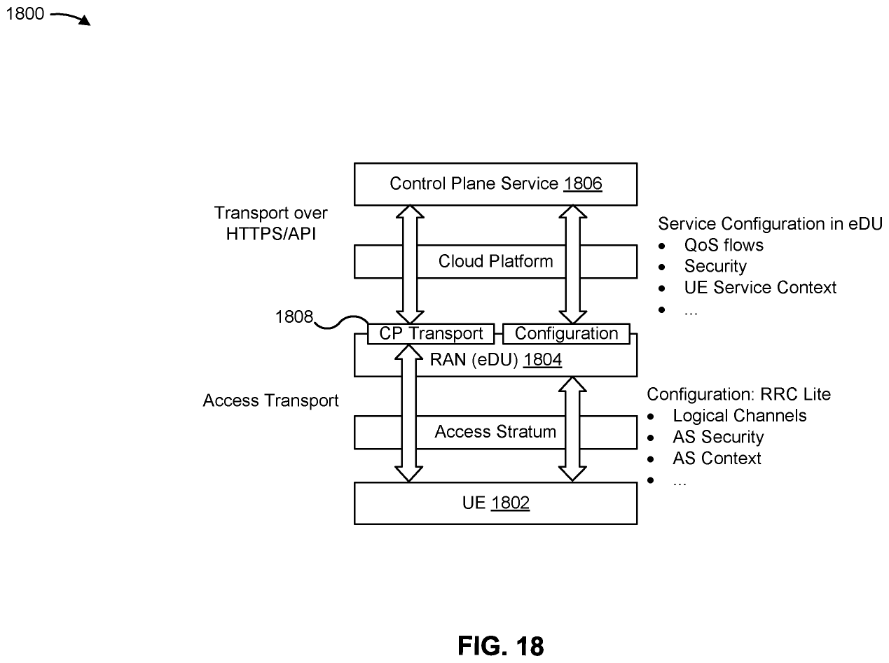

FIG. 18 is a diagram illustrating an example 1800 of a service based architecture, in accordance with the present disclosure.

In some aspects, a UE 1802 may signal a control plane service 1806 using a control plane transport 1808 in an end-to-end control plane signaling solution. The control plane transport 1808 may be a common transport for all services. The RAN 1804 may be involved only in routing, with no insight into with which service the UE 1802 is communicating. The end-to-end security may be independent of the specific service (support of zero trust paradigm).

In some aspects, there may be one or more control plane transport APIs between the RAN 1804 and the control plane service 1806. The APIs may leverage service-based interfaces (SBIs). The control plane service 1806 may use a configuration API to request a specific RAN configuration. The RAN may aggregate requests for different services and may accept, modify, or reject requests.

The UE 1802 may use the control plane transport 1808 to request services and to receive configurations for services. A configuration may be a local configuration. The configuration may be a service-specific configuration (e.g., logical channels corresponding to QoS flows) or a service-agnostic configuration that is intrinsic to eDU-UE connected operation and common to all services.

As indicated above, FIG. 18 is provided as an example. Other examples may differ from what is described with regard to FIG. 18.

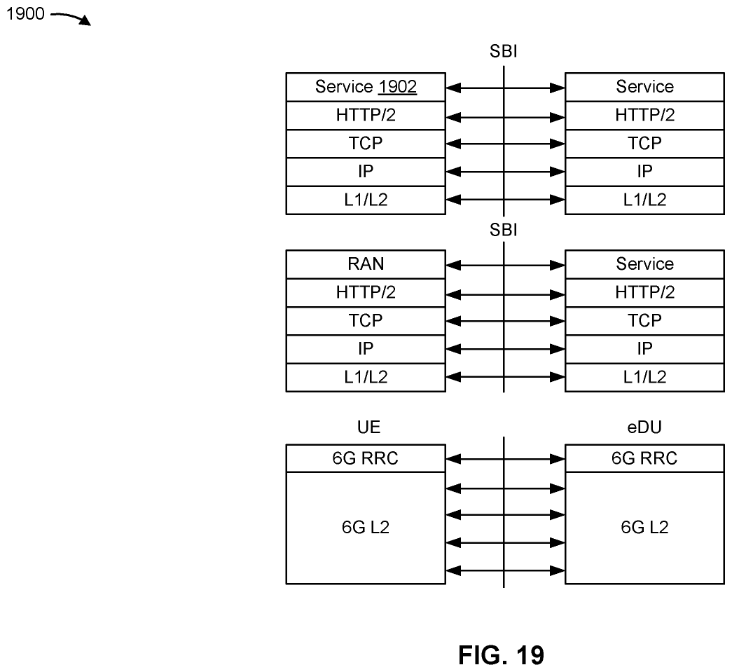

FIG. 19 is a diagram illustrating an example 1900 of a control plane protocol stack, in accordance with the present disclosure. The control plane transport may use a network service layer 1902 for signaling between core network entities or between a RAN (e.g., eDU) network entity and a core network entity. The control plane transport may reuse an SBI. A UE may use a 6G RRC layer for AS signaling between the UE and the RAN, when a local configuration is used.

As indicated above, FIG. 19 is provided as an example. Other examples may differ from what is described with regard to FIG. 19.

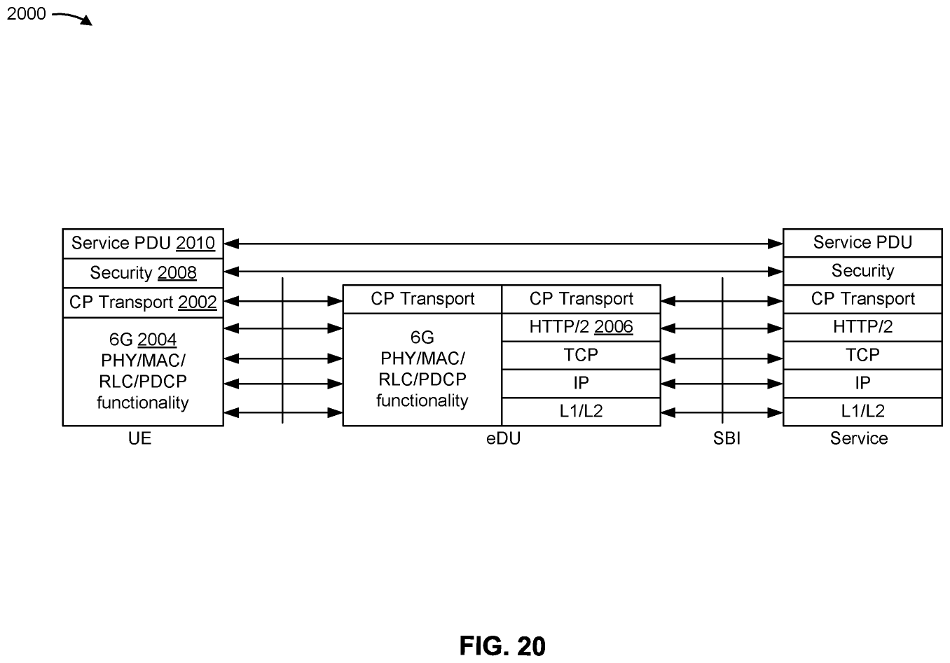

FIG. 20 is a diagram illustrating an example 2000 of a control plane protocol stack, in accordance with the present disclosure. In some aspects, as shown by the control plane protocol stack in example 2000, the UE may use a control plane transport layer 2002 that sits on a 6G layer 2004 that provides L1 or L2 functionality (e.g., PHY, MAC, RLC, PDCP) for signaling between the UE and the RAN (e.g., eDU). The RAN (e.g., eDU) may use the control plane transport layer 2002 on top of internet based layers 2006, such as a hypertext transfer protocol (HTTP) layer, a transmission control protocol (TCP) layer, an IP layer, and an L1/L2 layer for signaling between the RAN and the control plane service. The UE may use the control plane transport layer 2002, a security layer 2008, and a service PDU layer 2010 for signaling between the UE and the control plane service. The security layer 2008 may provide end-to-end security in line with a Zero Trust paradigm. The same security layer protocol may be used for different service PDUs. In some aspects, services may be interpreted as being in the application layer. Service PDUs may be considered “application PDUs” at the application layer.

In some aspects, the control plane transport layer 2002 may provide an addressing solution over the control plane. The control plane transport layer 2002 may be independent of the service with which the UE is communicating. The service may be identified by a Service ID. The UE may be identified by a temporary UE ID.

The control plane protocol stack may provide for full independence between the control plane transport and the control plane service. New control plane services may be added without affecting other existing network services. The control plane transport may be used at the RAN independent of whatever control plane service is selected. The control plane transport may minimize interdependency between the RAN and the core network. The control plane transport provides for an end-to-end security solution (e.g., achieve Zero Trust end-to-end security solution in 6G). One security layer solution may be defined for all services.

As indicated above, FIG. 20 is provided as an example. Other examples may differ from what is described with regard to FIG. 20.

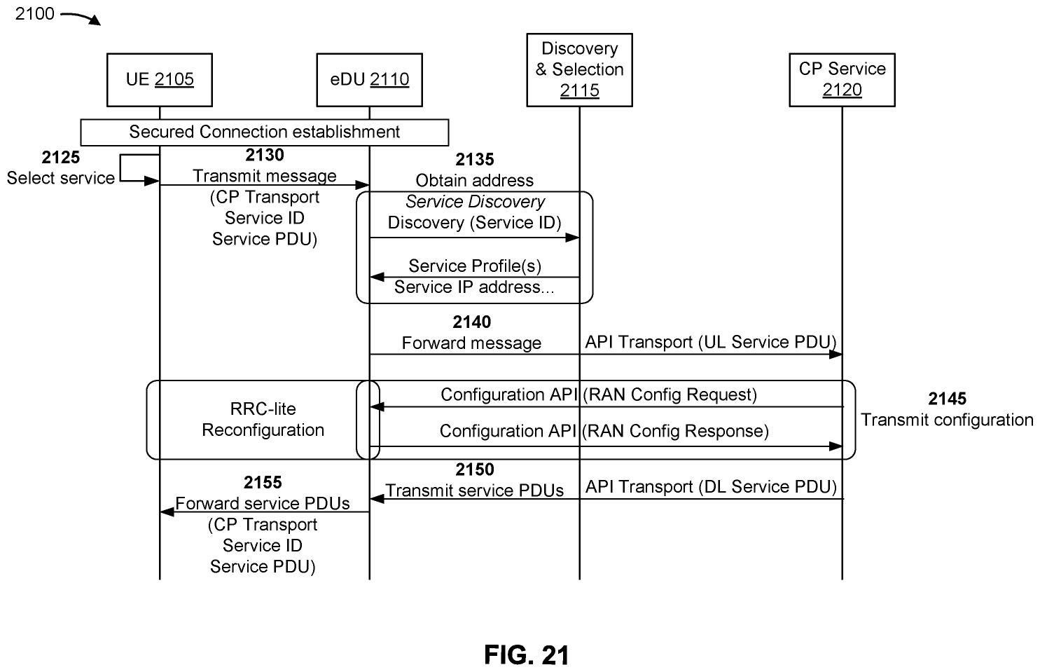

FIG. 21 is a diagram illustrating an example 2100 of a control plane transport flow, in accordance with the present disclosure. Example 2100 shows a UE 2105 (e.g., UE 120) and a RAN eDU 2110 (e.g., network node 110) that may communicate with one another over a wireless network (e.g., wireless network 100). The eDU 2110 may communicate with core network entities such as a discovery and selection service 2115 (e.g., core network node 130) and a CP service 2120 (e.g., core network node 130).

At 2125, the UE 2105 may select a service that is provided over the control plane. At 2130, the UE 2105 may transmit a message to a CP transport on a CP transport layer. The message may be a service PDU with a control plane transport header that includes an indication of the service (e.g., service ID) and a UE ID of the UE 2105. The message may be encrypted.

The eDU 2110 may request the discovery and selection service 2115 to resolve the service ID. At 2135, the eDU 2110 may obtain an address for the service. In some aspects, the service ID may be mapped to the address, either at the eDU 2110 or at the discovery and selection service 2115. The eDU 2110 may transmit a service discovery message with the service ID to the discovery and selection service 2115. The discovery and selection service 2115 may select a specific service instance for the service ID. The discovery and selection service 2115 may transmit all necessary information to the eDU 2110. This information may include a service profile and a service address (e.g., IP address). The eDU 2110 may store this service IP address for future forwarding. At 2140, the eDU 2110 may forward the message to the service IP address. The eDU 2110 may use a transport API for uplink service PDUs. In some aspects, eDU 2110 may use tunneling, such as over HTTP2/TCP/IP or HTTP3/quick user datagram protocol (UDP) internet connection (QUIC)/UDP/IP.

At 2145, the CP service 2120 may transmit a configuration for the service. The CP service 2120 may use a configuration API for a RAN configuration request and receive a RAN configuration response. The eDU 2110 may use an RRC-lite reconfiguration that involves less information and signaling to convey the configuration for the service to the UE 2105.

At 2145, the CP service 2120 may transmit service PDUs for the CP service 2120. At 2150, the CP service 2120 may use a transport API to transmit downlink service PDUs. At 2155, the eDU 2110 may forward the service PDUs. The service PDUs may each have a CP transport header that includes a service ID for the service and a UE ID for the UE.

As indicated above, FIG. 21 is provided as an example. Other examples may differ from what is described with regard to FIG. 21.

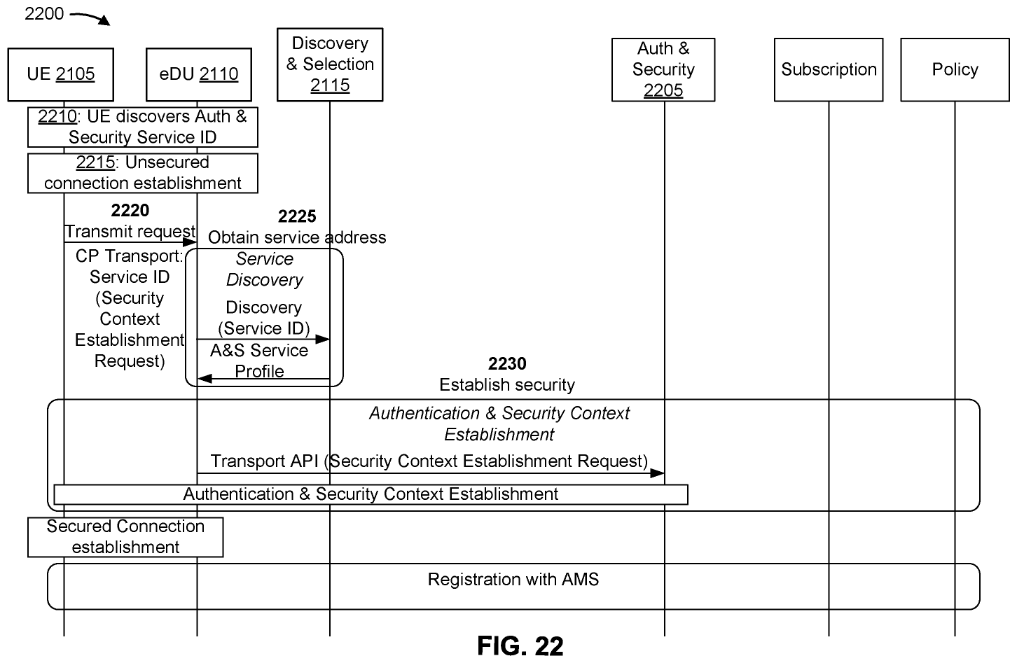

FIG. 22 is a diagram illustrating an example 2200 of security context flow, in accordance with the present disclosure. The eDU 2110 may communicate with an authentication and security service 2205 (e.g., core network node 130).

In some aspects, the authentication and security service 2205 and the discovery and selection services are special. Such services are configured at the UE 2105 and the eDU 2110 and may be used ahead of any service selected by the UE 2105. The authentication and security service ID may be discovered by the UE 2105 before any authentication and authorization is performed. At 2210, the UE 2105 may determine the authentication and security service ID. The authentication and security service ID may be provided via unsecured system information as part of an unsecured connection establishment, such as at 2215. The discovery and selection service 2115 may be the entry point for the UE 2105 to discover services, so its own service ID may be discoverable by all UEs. The authentication and security service ID and/or the discovery and selection service ID may be received by the UE 2105 in system information and/or a preconfiguration (e.g., per public land mobile network (PLMN)). In some aspects, these service IDs may be established as standard service IDs.

At 2220, the UE 2105 may transmit a request to establish a security context. The UE 2105 may select an authentication and security service 2205 and transmit the request with the service ID for the authentication and security service 2205. At 2225, the eDU 2110 may obtain the service address for the authentication and security service. For example, the eDU 2110 may transmit the service ID and receive an authentication and security service profile. The profile may include or come with an address for the authentication and security service 2205.

At 2230, the UE 2105 may establish security with the authentication and security service 2205. The eDU 2110 may forward the request for security to the authentication and security service 2205. The authentication and security service 2205 may establish security with the UE 2105. This may include authenticating the UE 2105, transmitting an encryption key, and/or setting privileges for the UE 2105. Having set up a secure connection, the UE 2105 may register with an AMS or another service on the control plane.

As indicated above, FIG. 22 is provided as an example. Other examples may differ from what is described with regard to FIG. 22.

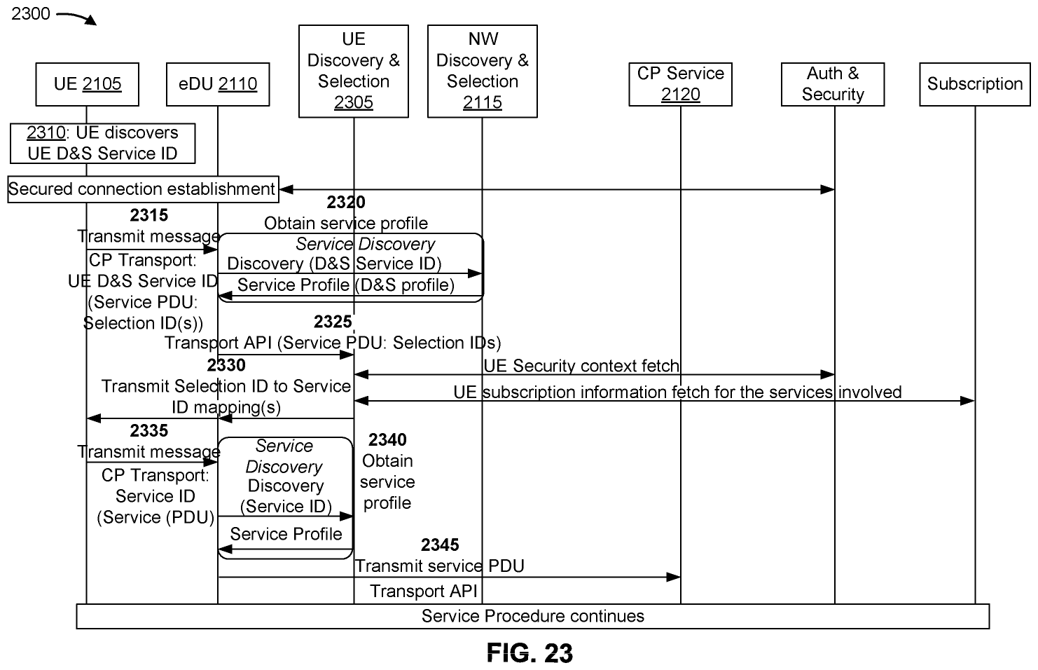

FIG. 23 is a diagram illustrating an example 2300 of service selection, in accordance with the present disclosure.

In some aspects, the UE may be configured with service selection information. The service selection information may identify a type of service (e.g. AMS, DSS). The service selection information may also include other information, such as a preferred vendor. The actual service ID is to be derived from the service selection information. The new design may be service independent, and the same selection framework may be used for AMS, DSS, or any other service over the control plane, including for future services (e.g., 7G).

Example 2300 shows that the UE 2105 may receive the service ID directly from a UE discovery and selection service 2305. At 2310, the UE 2105 may discover the service ID for the UE discovery and selection service. The UE 2105 may establish a context with the UE discovery and selection service 2305, which provides a list of services with service selection information. Each of the services may have a service ID that is mapped to a selection ID.

At 2315, the UE 2105 may transmit a message to the eDU 2110. The message may include a control plane transport header with the UE ID, the UE service and discovery service ID, and one or more selection IDs. At 2320, the eDU 2110 may obtain a service profile using a service ID of the network discovery and selection service 2115. At 2325, the eDU 2110 may transmit a service PDU to the UE discovery and selection service 2305 with the one or more selection IDs received from the UE 2105. At 2330, the eDU 2110 may transmit selection ID to service ID mappings (or just the service IDs) to the UE 2105.

At 2335, the UE 2105 may transmit a message to the eDU 2110 with a control plane transport header that has the UE ID and the service ID of a selected service. At 2340, the eDU 2110 may obtain a service profile from the UE discovery and selection service 2305. The service profile may include an address for the service. At 2345, the UE 2105 may transmit a service PDU to the address of the selected service (CP service 2120). The procedure for the control plane service may continue for the UE 2105.

In some aspects, a service may include multiple service modules. A service module may provide a specific subset of services. A service module may be associated with a service module ID. The UE 2105, the eDU 2110, the discovery and selection service 2115, and the CP service 2120 may be configured to use different combinations of service modules. This modularization of services allows the core network to add core network services without changing the selection and addressing of the control plane services.

In some aspects, the UE 2105 may use a service selection ID for an initial selection of control plane services (e.g., AMS, DSS). The UE 2105 may transmit a message for the service, where the message includes a field for the service type and a field for the dedicated service selection ID. The service type may indicate the type of service (e.g., AMS for enhanced mobile broadband (eMBB) devices, AMS for IoT devices, DSS). The service type may correspond to a minimum required functionality for the UE and/or the service. There may be a default set of service module types. The dedicated service selection ID may identify a specific service selection (e.g., vendor specific, operator controlled) of the service type. The UE 2105 may assign a service a temporary service ID after an initial selection. The UE 2105 may use the temporary service ID to address a service.

In some aspects, there may be multiple service module IDs per service ID. The message for service may include a service module type field and a service module selection ID field. The service module type may be specific to the service type. For the AMS type, there may be the services of security, mobility, and transport. For the DSS type, there may be the services of SMF and SM-PCF. The dedicated service module ID may identify a specific service module of the service module type. In some aspects, the UE 2105 may use a temporary service module ID for module instantiation.

As indicated above, FIG. 23 is provided as an example. Other examples may differ from what is described with regard to FIG. 23.

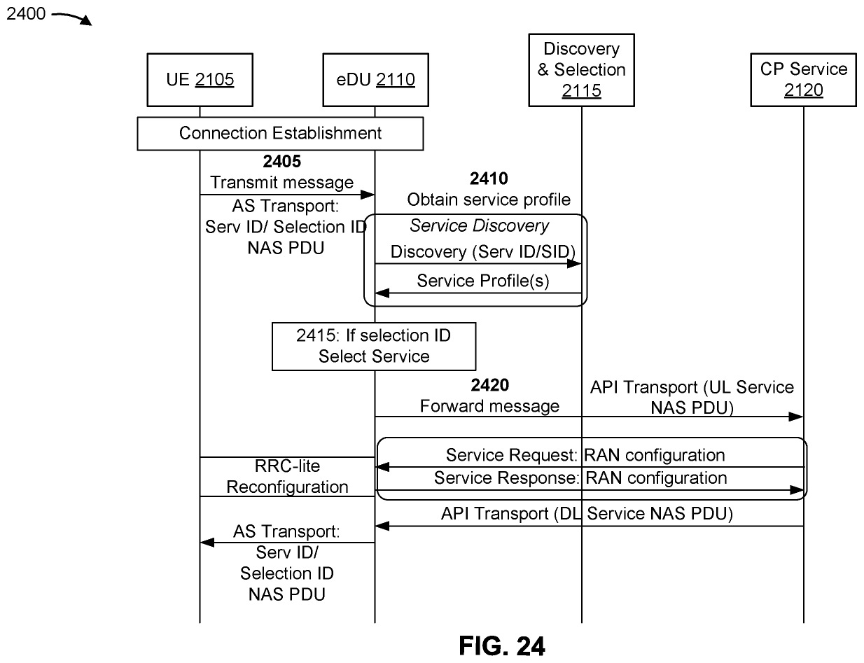

FIG. 24 is a diagram illustrating an example 2400 of service selection, in accordance with the present disclosure.

In some aspects, the control plane transport header may be used to transmit NAS PDUs, or service PDUs. The control plane transport header may be unaltered from end-to-end, or between the UE 2105 and the CP Service 2120. In some aspects, an AS transport header may be added to the NAS PDU. The AS header may be used for communication between the UE 2105 and the eDU 2110, and the AS header may be changed when the NAS PDU is forwarded from the eDU 2110 to the CP service 2120.

At 2405, the UE 2105 may transmit a message, which may be a NAS PDU. The NAS PDU may include a service ID or a selection ID in the AS transport header. The AS transport header may include a temporary service ID (e.g., AMS service ID) during registration with a 6G network, if a context has been created for the service. The UE 2105 may use a service selection ID for initial context establishment. A temporary service ID may not be known to the UE 2105. The temporary service ID may be used at the eDU 2110 to select a service or network function (e.g., Service Exposure and Orchestration Function (SEOF)) and to forward a NAS PDU to the selected service or function.

In some aspects, the AS Transport may be included in RRC-lite or a separate protocol that uses less signaling or information than RRC reconfiguration. The UE 2105 may establish an AS security context.

At 2410, the eDU 2110 may obtain a service profile with the service ID or the selection ID. At 2415, if the eDU 2110 has a selection ID, the eDU 2110 may select a service. At 2420, the eDU 2110 may forward the message (NAS PDU) to the CP Service 2120. The UE 2105 may then receive a configuration and use the service on the control plane similar to as shown in example 2100 of FIG. 21.

As indicated above, FIG. 24 is provided as an example. Other examples may differ from what is described with regard to FIG. 24.

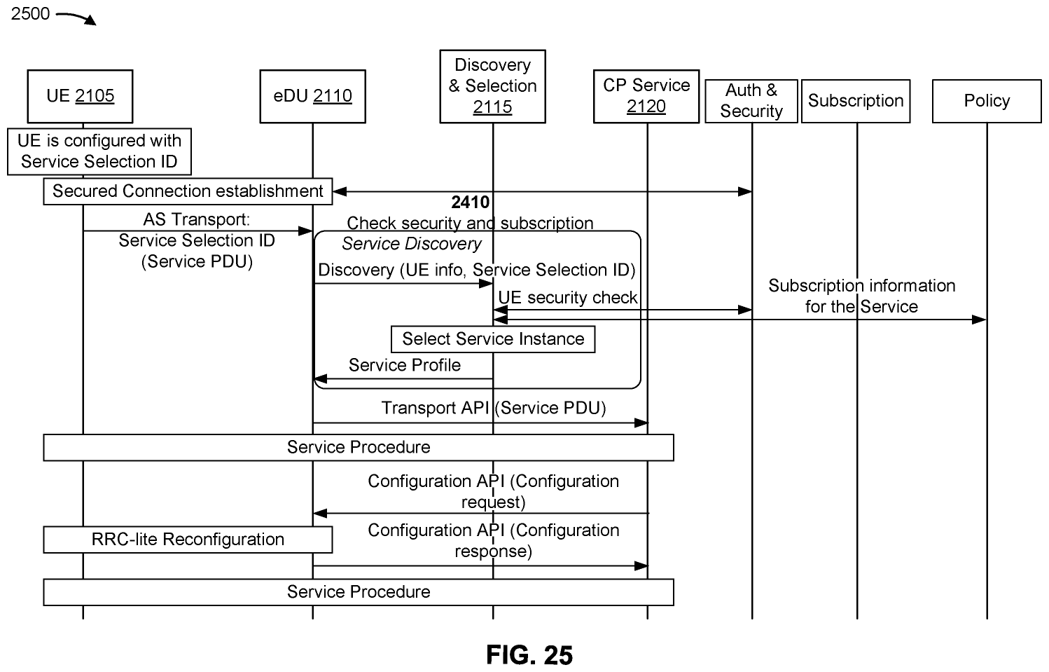

FIG. 25 is a diagram illustrating an example 2500 of service selection, in accordance with the present disclosure.

The UE 2105 may provide a message with the service selection ID to the eDU 2110. The message may be a service PDU. However, in some aspects, the eDU 2110 may forward this service selection ID to the discovery and selection service 2115 (without performing a check). At 2410, the discovery and selection service 2115 may check security and the subscription (e.g. check whether the UE 2105 is authorized to reach the service). The discovery and selection service 2115 may select the service and provide the service profile (e.g., service address) to the eDU 2110. The eDU 2110 may then forward the message to the CP service 2120 similar to as described in example 2100 of FIG. 21.

As indicated above, FIG. 25 is provided as an example. Other examples may differ from what is described with regard to FIG. 25.

FIG. 26 is a flowchart of an example method 2600 of wireless communication. The method 2600 may be performed at, for example, a UE (e.g., UE 120, UE 2105) or an apparatus of a UE.

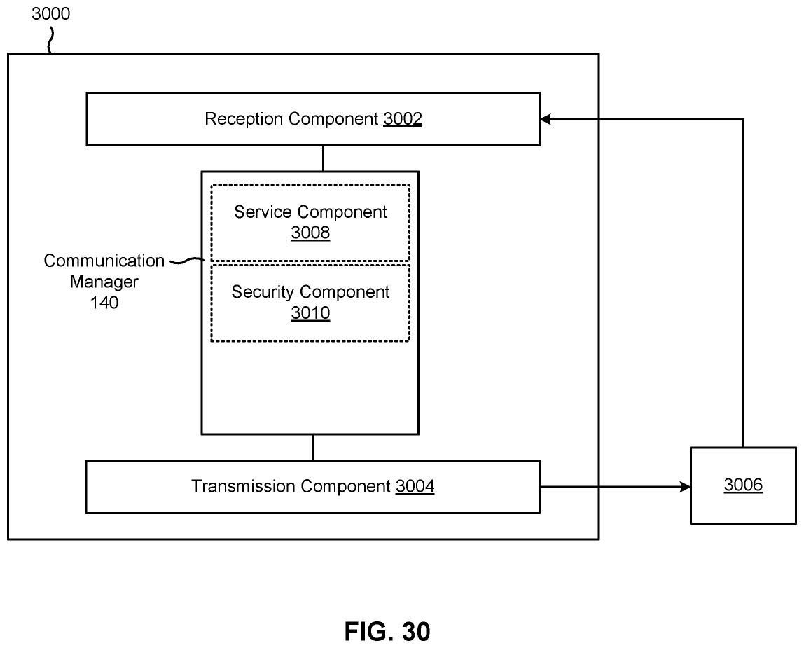

At 2610, the UE may select a service provided over a control plane. For example, the UE (e.g., using communication manager 140 and/or service component 3008, depicted in FIG. 30) may select a service provided over a control plane, as described above in connection with, for example, FIGS. 16-25. In some aspects, the service may be an AMS over the control plane, a DSS over the control plane, a subscription service over the control plane, a policy service over the control plane, or an NEF over the control plane.

At 2620, the UE may transmit a message that includes an indication of the service and a UE ID for the UE. For example, the UE (e.g., using communication manager 140 and/or transmission component 3004, depicted in FIG. 30) may transmit a message that includes an indication of the service and a UE ID for the UE, as described above in connection with, for example, FIGS. 16-25. In some aspects, the message includes a first PDU with a control plane transport header that includes the indication of the service and the UE ID. In some aspects, the control plane transport header is associated with a control plane transport protocol layer, and the first PDU is a service PDU associated with a service PDU protocol layer. In some aspects, the PDU includes an NAS PDU. In some aspects, the indication of the service includes a service ID or service selection information associated with a service ID. The service selection information may include a service selection ID.

In some aspects, method 2600 includes establishing security for the UE using a security service with messaging on a security protocol layer between the control plane transport protocol layer and the service PDU protocol layer. In some aspects, establishing security for the UE includes selecting an authentication and security service, and the indication of the service indicates the authentication and security service.

At 2630, the UE may receive a configuration for the service. For example, the UE (e.g., using communication manager 140 and/or reception component 3002, depicted in FIG. 30) may receive a configuration for the service, as described above in connection with, for example, FIGS. 16-25. In some aspects, method 2600 includes transmitting one or more PDUs associated with use of the service over the control plane. The PDUs may be transmitted using the configuration.

In some aspects, method 2600 includes obtaining a service ID for a discovery and selection service that indicates available services on the control plane. Obtaining the service ID for the discovery and selection service may include receiving the service ID in system information or via a configuration. Method 2600 may include obtaining the service ID for the discovery and selection service includes obtaining a preconfigured service ID (e.g., according to a wireless communication standard). In some aspects, alone or in combination with one or more of the first through twelfth aspects, method 2600 includes receiving a service module ID for a service module associated with the service.

Although FIG. 26 shows example blocks of method 2600, in some aspects, method 2600 may include additional blocks, fewer blocks, different blocks, or differently arranged blocks than those depicted in FIG. 26. Additionally, or alternatively, two or more of the blocks of method 2600 may be performed in parallel.

FIG. 27 is a flowchart of an example method 2700 of wireless communication. The method 2700 may be performed at, for example, a first network entity (e.g., network node 110, eDU 2110) or an apparatus of a first network entity.

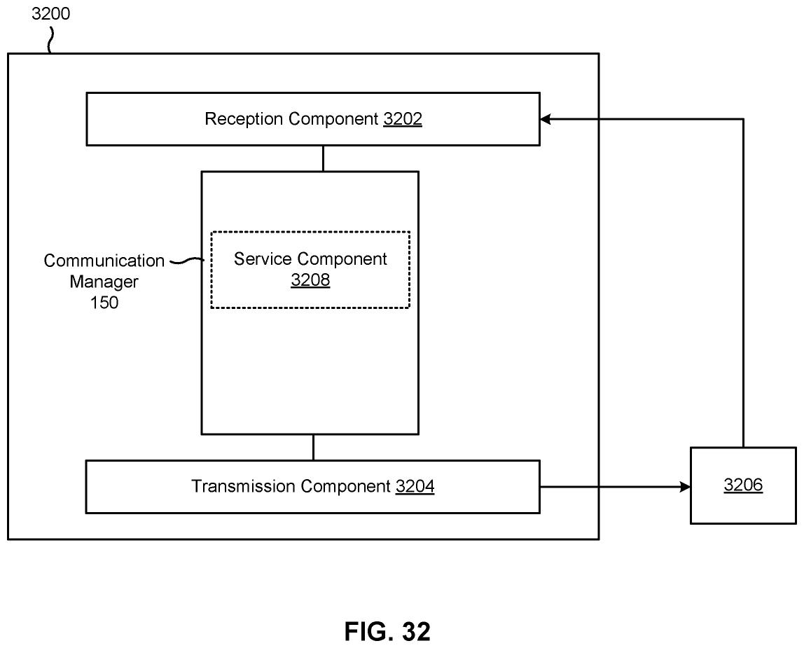

At 2710, the first network entity may receive, from a UE, a message that includes an indication of a service provided over a control plane and a UE ID for the UE. For example, the first network entity (e.g., using communication manager 150 and/or reception component 3202, depicted in FIG. 32) may receive, from a UE, a message that includes an indication of a service provided over a control plane and a UE ID for the UE, as described above in connection with, for example, FIGS. 16-25. The message may include a first PDU with a control plane transport header that includes the indication of the service and the UE ID. The address may be associated with the service ID. In some aspects, the address is an IP address. In some aspects, the first network entity may map the address to the service. The message may include a first PDU with a control plane transport header that includes the indication of the service and the UE ID.

In some aspects, the indication of the service includes service selection information associated with a service ID, and method 2700 includes transmitting the service selection information with a request for the service ID to a second network entity of a discovery and selection service, and receiving one or more of the address for the service or the service ID. In some aspects, method 2700 includes transmitting the service ID to the UE.

In some aspects, the indication of the service includes a service selection ID, the message includes an NAS PDU, and method 2700 includes selecting an SEOF using the service selection ID, and forwarding the NAS PDU to the SEOF.

At 2720, the first network entity may forward the message to an address for the service based at least in part on the indication of the service. For example, the first network entity (e.g., using communication manager 150 and/or transmission component 3204, depicted in FIG. 32) may forward the message to an address for the service based at least in part on the indication of the service, as described above in connection with, for example, FIGS. 16-25. In some aspects, the address is an IP address. In some aspects, the first network entity may use tunneling, such as HTTP2 or HTTP3 over QUIC/UDP/IP or TCP/IP. In some aspects, the first network entity may map the address to the service.

At 2730, the first network entity may transmit a configuration for the service to the UE. For example, the first network entity (e.g., using communication manager 150 and/or transmission component 3204, depicted in FIG. 32) may transmit a configuration for the service to the UE, as described above in connection with, for example, FIGS. 16-25.

Although FIG. 27 shows example blocks of method 2700, in some aspects, method 2700 may include additional blocks, fewer blocks, different blocks, or differently arranged blocks than those depicted in FIG. 27. Additionally, or alternatively, two or more of the blocks of method 2700 may be performed in parallel.

FIG. 28 is a flowchart of an example method 2800 of wireless communication. The method 2800 may be performed at, for example, a second network entity (e.g., core network node 130, discovery and selection service 2115) or an apparatus of a second network entity.

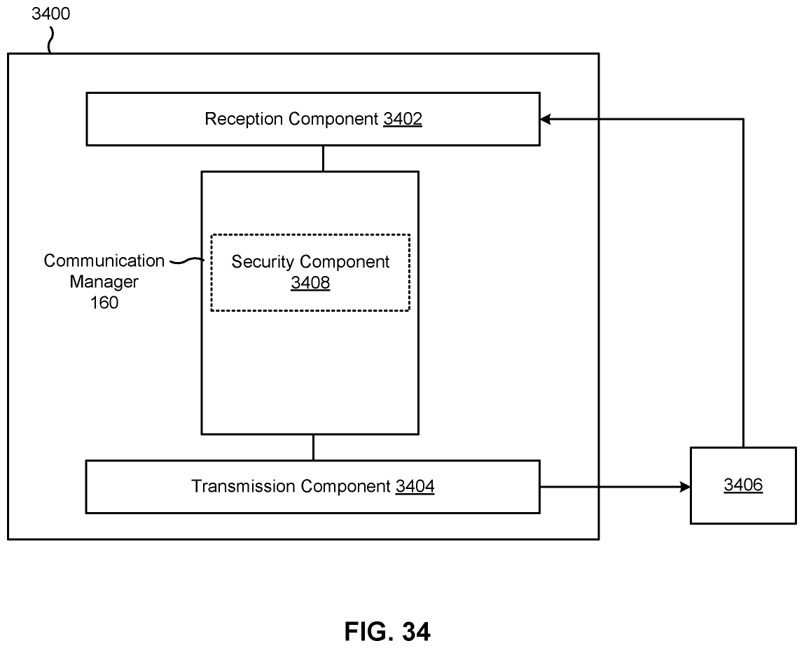

At 2810, the second network entity may receive, from a first network entity, service selection information associated with a service. For example, the second network entity (e.g., using communication manager 160 and/or reception component 3402, depicted in FIG. 34) may receive, from a first network entity, service selection information associated with a service, as described above in connection with, for example, FIGS. 16-25. In some aspects, method 2800 includes performing a security check for a UE, and receiving subscription information for the service.

At 2820, the second network entity may transmit, to the first network entity, a service ID associated with the service. For example, the second network entity (e.g., using communication manager 160 and/or transmission component 3404, depicted in FIG. 34) may transmit, to the first network entity, a service ID associated with the service, as described above in connection with, for example, FIGS. 16-25.

At 2830, the second network entity may transmit, to the first network entity, an address for the service or a service profile for the service. For example, the second network entity (e.g., using communication manager 160 and/or transmission component 3404, depicted in FIG. 34) may transmit, to the first network entity, an address for the service or a service profile for the service, as described above in connection with, for example, FIGS. 16-25. In some aspects, the service profile is for a discovery and selection service or an authentication and security service.

Although FIG. 28 shows example blocks of method 2800, in some aspects, method 2800 may include additional blocks, fewer blocks, different blocks, or differently arranged blocks than those depicted in FIG. 28. Additionally, or alternatively, two or more of the blocks of method 2800 may be performed in parallel.

FIG. 29 is a flowchart of an example method 2900 of wireless communication. The method 2900 may be performed at, for example, a network entity (e.g., core network node 130, CP service 2120) or an apparatus of a network entity.

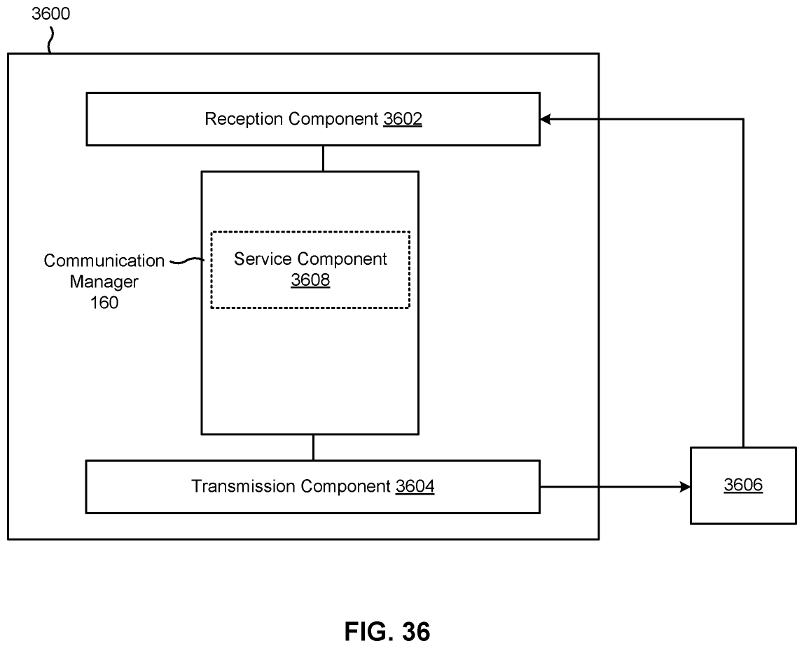

At 2910, the network entity may receive a message that includes an indication of a service provided over a control plane and a UE ID for the UE. For example, the network entity (e.g., using communication manager 160 and/or reception component 3602, depicted in FIG. 36) may receive a message that includes an indication of a service provided over a control plane and a UE ID for the UE, as described above in connection with, for example, FIGS. 16-25.

At 2920, the network entity may transmit a configuration for the service. For example, the network entity (e.g., using communication manager 160 and/or transmission component 3604, depicted in FIG. 36) may transmit a configuration for the service, as described above in connection with, for example, FIGS. 16-25.

At 2930, the network entity may transmit one or more PDUs associated with use of the service over the control plane. For example, the network entity (e.g., using communication manager 160 and/or transmission component 3604, depicted in FIG. 36) may transmit one or more PDUs associated with use of the service over the control plane, as described above in connection with, for example, FIGS. 16-25.

Although FIG. 29 shows example blocks of method 2900, in some aspects, method 2900 may include additional blocks, fewer blocks, different blocks, or differently arranged blocks than those depicted in FIG. 29. Additionally, or alternatively, two or more of the blocks of method 2900 may be performed in parallel.

FIG. 30 is a diagram of an example apparatus 3000 for wireless communication, in accordance with the present disclosure. The apparatus 3000 may be a UE (e.g., UE 120, UE 2105), or a UE may include the apparatus 3000. In some aspects, the apparatus 3000 includes a reception component 3002 and a transmission component 3004, which may be in communication with one another (for example, via one or more buses and/or one or more other components). As shown, the apparatus 3000 may communicate with another apparatus 3006 (such as a UE, a base station, or another wireless communication device) using the reception component 3002 and the transmission component 3004. As further shown, the apparatus 3000 may include the communication manager 140. The communication manager 140 may include a service component 3008 and/or a security component 3010, among other examples.

In some aspects, the apparatus 3000 may be configured to perform one or more operations described herein in connection with FIGS. 1-25. Additionally, or alternatively, the apparatus 3000 may be configured to perform one or more processes described herein, such as method 2600 of FIG. 26. In some aspects, the apparatus 3000 and/or one or more components shown in FIG. 30 may include one or more components of the UE described in connection with FIG. 2. Additionally, or alternatively, one or more components shown in FIG. 30 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 3002 may receive communications, such as reference signals, control information, data communications, or a combination thereof, from the apparatus 3006. The reception component 3002 may provide received communications to one or more other components of the apparatus 3000. In some aspects, the reception component 3002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 3000. In some aspects, the reception component 3002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 3004 may transmit communications, such as reference signals, control information, data communications, or a combination thereof, to the apparatus 3006. In some aspects, one or more other components of the apparatus 3000 may generate communications and may provide the generated communications to the transmission component 3004 for transmission to the apparatus 3006. In some aspects, the transmission component 3004 may perform signal processing on the generated communications (such as filtering, amplification, modulation, digital-to-analog conversion, multiplexing, interleaving, mapping, or encoding, among other examples), and may transmit the processed signals to the apparatus 3006. In some aspects, the transmission component 3004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 3004 may be co-located with the reception component 3002 in one or more transceivers.

The service component 3008 may select a service provided over a control plane. The transmission component 3004 may transmit a message that includes an indication of the service and a UE ID for the UE. The service component 3008 may obtain a service ID for a discovery and selection service that indicates available services on the control plane. The reception component 3002 may receive a service module ID for a service module associated with the service.

The reception component 3002 may receive a configuration for the service. The transmission component 3004 may transmit one or more PDUs associated with use of the service over the control plane. The security component 3010 may establish security for the UE using a security service with messaging on a security protocol layer between the control plane transport protocol layer and the service PDU protocol layer.

The number and arrangement of components shown in FIG. 30 are provided as an example. In practice, there may be additional components, fewer components, different components, or differently arranged components than those shown in FIG. 30. Furthermore, two or more components shown in FIG. 30 may be implemented within a single component, or a single component shown in FIG. 30 may be implemented as multiple, distributed components. Additionally, or alternatively, a set of (one or more) components shown in FIG. 30 may perform one or more functions described as being performed by another set of components shown in FIG. 30.

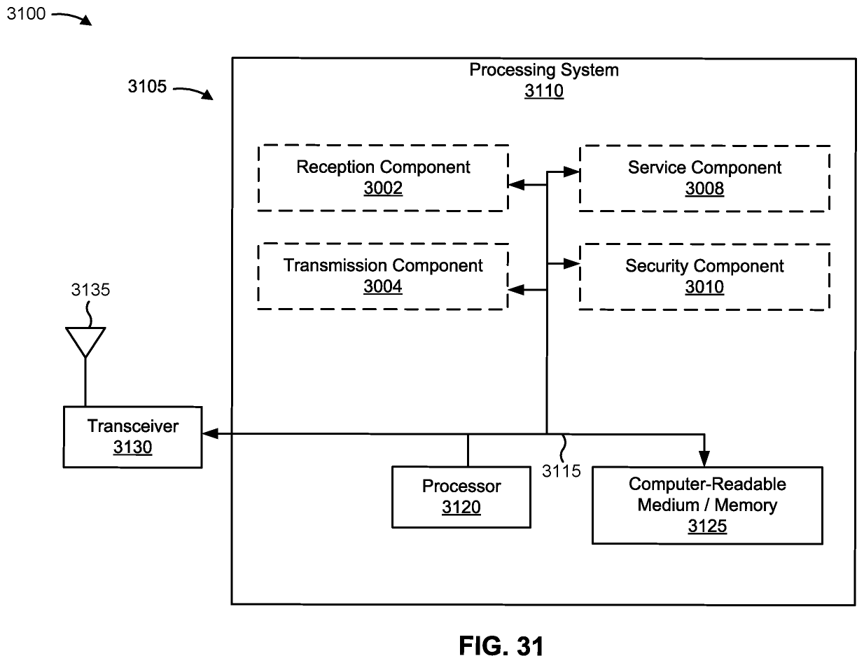

FIG. 31 is a diagram illustrating an example 3100 of a hardware implementation for an apparatus 3105 employing a processing system 3110, in accordance with the present disclosure. The apparatus 3105 may be a UE or may be at (e.g., included in) a UE.

The processing system 3110 may be implemented with a bus architecture, represented generally by the bus 3115. The bus 3115 may include any number of interconnecting buses and bridges depending on the specific application of the processing system 3110 and the overall design constraints. The bus 3115 links together various circuits including one or more processors and/or hardware components, represented by the processor 3120, the illustrated components, and the computer-readable medium/memory 3125. The bus 3115 may also link various other circuits, such as timing sources, peripherals, voltage regulators, and/or power management circuits.

The processing system 3110 may be coupled to one or more transceivers 3130. A transceiver 3130 is coupled to one or more antennas 3135. The transceiver 3130 provides a means for communicating with various other apparatuses over a transmission medium. The transceiver 3130 receives a signal from the one or more antennas 3135, extracts information from the received signal, and provides the extracted information to the processing system 3110, specifically the reception component 3002. In addition, the transceiver 3130 receives information from the processing system 3110, specifically the transmission component 3004, and generates a signal to be applied to the one or more antennas 3135 based at least in part on the received information.

The processing system 3110 includes one or more processors 3120 coupled to a computer-readable medium/memory 3125. A processor 3120 is responsible for general processing, including the execution of software stored on the computer-readable medium/memory 3125. The software, when executed by the processor 3120, causes the processing system 3110 to perform the various functions described herein for any particular apparatus. The computer-readable medium/memory 3125 may also be used for storing data that is manipulated by the processor 3120 when executing software. The processing system further includes at least one of the illustrated components. The components may be software modules running in the processor 3120, resident/stored in the computer readable medium/memory 3125, one or more hardware modules coupled to the processor 3120, or some combination thereof.

In some aspects, the processing system 3110 maybe a component of the UE 120 and may include one or more memories, such as the memory 282, and/or may include one or more processors, such as at least one of the TX MIMO processor 266, the RX processor 258, and/or the controller/processor 280. In some aspects, the apparatus 3105 for wireless communication includes means for selecting a service provided over a control plane; means for transmitting a message that includes an indication of the service and an identifier for the apparatus; and means for receiving a configuration for the service. The aforementioned means may be one or more of the aforementioned components of the apparatus 3000 and/or the processing system 3110 of the apparatus 3105 configured to perform the functions recited by the aforementioned means. As described elsewhere herein, the processing system 3110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 31 is provided as an example. Other examples may differ from what is described in connection with FIG. 31.

FIG. 32 is a diagram of an example apparatus 3200 for wireless communication, in accordance with the present disclosure. The apparatus 3200 may be a first network entity (e.g., network node 110, eDU 2110), or a first network entity may include the apparatus 3200. In some aspects, the apparatus 3200 includes a reception component 3202 and a transmission component 3204, which may be in communication with one another (for example, via one or more buses and/or one or more other components). As shown, the apparatus 3200 may communicate with another apparatus 3206 (such as a UE, a base station, or another wireless communication device) using the reception component 3202 and the transmission component 3204. As further shown, the apparatus 3200 may include the communication manager 150 The communication manager 150 may include a service component 3208, among other examples.

In some aspects, the apparatus 3200 may be configured to perform one or more operations described herein in connection with FIGS. 1-25. Additionally, or alternatively, the apparatus 3200 may be configured to perform one or more processes described herein, such as method 2700 of FIG. 27. In some aspects, the apparatus 3200 and/or one or more components shown in FIG. 32 may include one or more components of the first network entity described in connection with FIG. 2. Additionally, or alternatively, one or more components shown in FIG. 32 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 3202 may receive communications, such as reference signals, control information, data communications, or a combination thereof, from the apparatus 3206. The reception component 3202 may provide received communications to one or more other components of the apparatus 3200. In some aspects, the reception component 3202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 3200. In some aspects, the reception component 3202 may include one or more antennas, one or more modems, one or more demodulators, one or more MIMO detectors, one or more receive processors, one or more controllers/processors, one or more memories, or a combination thereof, of the first network entity described in connection with FIG. 2.

The transmission component 3204 may transmit communications, such as reference signals, control information, data communications, or a combination thereof, to the apparatus 3206. In some aspects, one or more other components of the apparatus 3200 may generate communications and may provide the generated communications to the transmission component 3204 for transmission to the apparatus 3206. In some aspects, the transmission component 3204 may perform signal processing on the generated communications (such as filtering, amplification, modulation, digital-to-analog conversion, multiplexing, interleaving, mapping, or encoding, among other examples), and may transmit the processed signals to the apparatus 3206. In some aspects, the transmission component 3204 may include one or more antennas, one or more modems, one or more modulators, one or more transmit MIMO processors, one or more transmit processors, one or more controllers/processors, one or more memories, or a combination thereof, of the first network entity described in connection with FIG. 2. In some aspects, the transmission component 3204 may be co-located with the reception component 3202 in one or more transceivers.

The reception component 3202 may receive, from a UE, a message that includes an indication of a service provided over a control plane and a UE ID for the UE. The transmission component 3204 may forward the message to an address for the service based at least in part on the indication of the service. The service component 3208 may map the address to the service. The transmission component 3204 may transmit a configuration for the service to the UE. The transmission component 3204 may transmit the service ID to the UE.

The number and arrangement of components shown in FIG. 32 are provided as an example. In practice, there may be additional components, fewer components, different components, or differently arranged components than those shown in FIG. 32. Furthermore, two or more components shown in FIG. 32 may be implemented within a single component, or a single component shown in FIG. 32 may be implemented as multiple, distributed components. Additionally, or alternatively, a set of (one or more) components shown in FIG. 32 may perform one or more functions described as being performed by another set of components shown in FIG. 32.

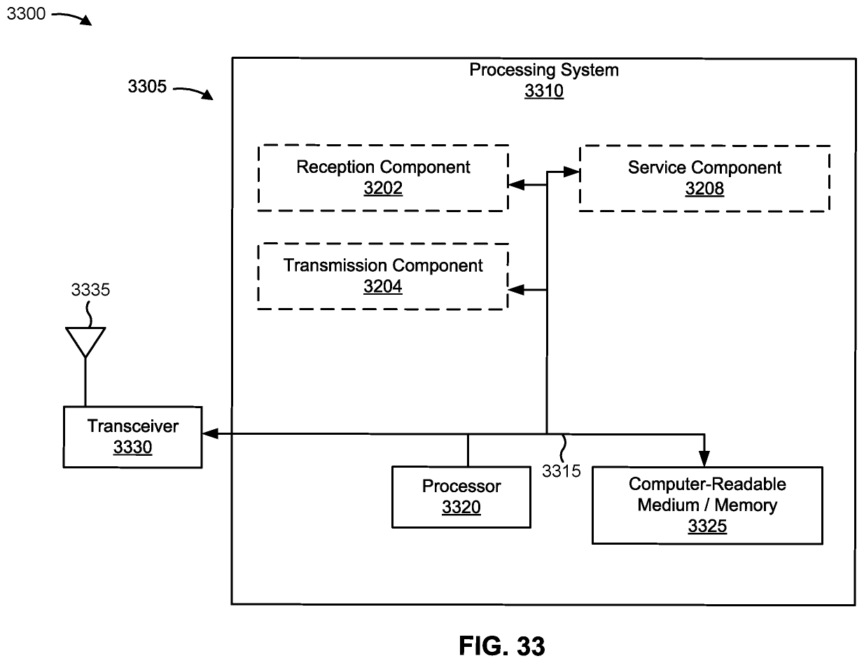

FIG. 33 is a diagram illustrating an example 3300 of a hardware implementation for an apparatus 3305 employing a processing system 3310, in accordance with the present disclosure. The apparatus 3305 may be a first network entity or may be at (e.g., included in) a first network entity.

The processing system 3310 may be implemented with a bus architecture, represented generally by the bus 3315. The bus 3315 may include any number of interconnecting buses and bridges depending on the specific application of the processing system 3310 and the overall design constraints. The bus 3315 links together various circuits including one or more processors and/or hardware components, represented by the processor 3320, the illustrated components, and the computer-readable medium/memory 3325. The bus 3315 may also link various other circuits, such as timing sources, peripherals, voltage regulators, and/or power management circuits.

The processing system 3310 may be coupled to one or more transceivers 3330. A transceiver 3330 is coupled to one or more antennas 3335. The transceiver 3330 provides a means for communicating with various other apparatuses over a transmission medium. The transceiver 3330 receives a signal from the one or more antennas 3335, extracts information from the received signal, and provides the extracted information to the processing system 3310, specifically the reception component 3202. In addition, the transceiver 3330 receives information from the processing system 3310, specifically the transmission component 3204, and generates a signal to be applied to the one or more antennas 3335 based at least in part on the received information.

The processing system 3310 includes one or more processors 3320 coupled to a computer-readable medium/memory 3325. A processor 3320 is responsible for general processing, including the execution of software stored on the computer-readable medium/memory 3325. The software, when executed by the processor 3320, causes the processing system 3310 to perform the various functions described herein for any particular apparatus. The computer-readable medium/memory 3325 may also be used for storing data that is manipulated by the processor 3320 when executing software. The processing system further includes at least one of the illustrated components. The components may be software modules running in the processor 3320, resident/stored in the computer readable medium/memory 3325, one or more hardware modules coupled to the processor 3320, or some combination thereof.

In some aspects, the processing system 3310 maybe a component of the network node 110 and may include one or more memories, such as the memory 242, and/or may include one or more processors, such as at least one of the TX MIMO processor 230, the RX processor 238, and/or the controller/processor 240. In some aspects, the apparatus 3305 for wireless communication includes means for receiving, from another apparatus, a message that includes an indication of a service provided over a control plane and an identifier for the other apparatus; and means for forwarding the message to an address for the service based at least in part on the indication of the service. The aforementioned means may be one or more of the aforementioned components of the apparatus 3200 and/or the processing system 3310 of the apparatus 3305 configured to perform the functions recited by the aforementioned means. As described elsewhere herein, the processing system 3310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 33 is provided as an example. Other examples may differ from what is described in connection with FIG. 33.

FIG. 34 is a diagram of an example apparatus 3400 for wireless communication, in accordance with the present disclosure. The apparatus 3400 may be a second network entity (e.g., core network node 130, discovery and selection service 2115), or a second network entity may include the apparatus 3400. In some aspects, the apparatus 3400 includes a reception component 3402 and a transmission component 3404, which may be in communication with one another (for example, via one or more buses and/or one or more other components). As shown, the apparatus 3400 may communicate with another apparatus 3406 (such as a UE, a base station, or another wireless communication device) using the reception component 3402 and the transmission component 3404. As further shown, the apparatus 3400 may include the communication manager 160. The communication manager 160 may include a security component 3408, among other examples.

In some aspects, the apparatus 3400 may be configured to perform one or more operations described herein in connection with FIGS. 1-25. Additionally, or alternatively, the apparatus 3400 may be configured to perform one or more processes described herein, such as method 2800 of FIG. 28. In some aspects, the apparatus 3400 and/or one or more components shown in FIG. 34 may include one or more components of the second network entity described in connection with FIG. 2. Additionally, or alternatively, one or more components shown in FIG. 34 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 3402 may receive communications, such as reference signals, control information, data communications, or a combination thereof, from the apparatus 3406. The reception component 3402 may provide received communications to one or more other components of the apparatus 3400. In some aspects, the reception component 3402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 3400. In some aspects, the reception component 3402 may include one or more antennas, one or more modems, one or more demodulators, one or more MIMO detectors, one or more receive processors, one or more controllers/processors, one or more memories, or a combination thereof, of the second network entity described in connection with FIG. 2.

The transmission component 3404 may transmit communications, such as reference signals, control information, data communications, or a combination thereof, to the apparatus 3406. In some aspects, one or more other components of the apparatus 3400 may generate communications and may provide the generated communications to the transmission component 3404 for transmission to the apparatus 3406. In some aspects, the transmission component 3404 may perform signal processing on the generated communications (such as filtering, amplification, modulation, digital-to-analog conversion, multiplexing, interleaving, mapping, or encoding, among other examples), and may transmit the processed signals to the apparatus 3406. In some aspects, the transmission component 3404 may include one or more antennas, one or more modems, one or more modulators, one or more transmit MIMO processors, one or more transmit processors, one or more controllers/processors, one or more memories, or a combination thereof, of the second network entity described in connection with FIG. 2. In some aspects, the transmission component 3404 may be co-located with the reception component 3402 in one or more transceivers.

The reception component 3402 may receive, from a first network entity, service selection information associated with a service. The transmission component 3404 may transmit, to the first network entity, a service ID associated with the service.

The transmission component 3404 may transmit, to the first network entity, an address for the service or a service profile for the service. The security component 3408 may perform a security check for a UE. The reception component 3402 may receive subscription information for the service.

The number and arrangement of components shown in FIG. 34 are provided as an example. In practice, there may be additional components, fewer components, different components, or differently arranged components than those shown in FIG. 34. Furthermore, two or more components shown in FIG. 34 may be implemented within a single component, or a single component shown in FIG. 34 may be implemented as multiple, distributed components. Additionally, or alternatively, a set of (one or more) components shown in FIG. 34 may perform one or more functions described as being performed by another set of components shown in FIG. 34.

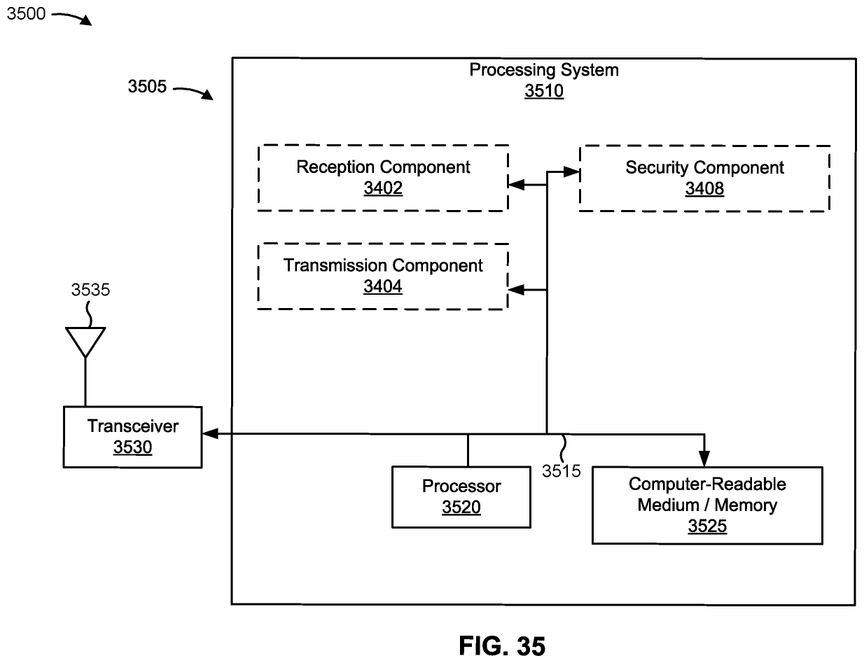

FIG. 35 is a diagram illustrating an example 3500 of a hardware implementation for an apparatus 3505 employing a processing system 3510, in accordance with the present disclosure. The apparatus 3505 may be a second network entity or may be at (e.g., included in) a second network entity.

The processing system 3510 may be implemented with a bus architecture, represented generally by the bus 3515. The bus 3515 may include any number of interconnecting buses and bridges depending on the specific application of the processing system 3510 and the overall design constraints. The bus 3515 links together various circuits including one or more processors and/or hardware components, represented by the processor 3520, the illustrated components, and the computer-readable medium/memory 3525. The bus 3515 may also link various other circuits, such as timing sources, peripherals, voltage regulators, and/or power management circuits.

The processing system 3510 may be coupled to one or more transceivers 3530. A transceiver 3530 is coupled to one or more antennas 3535. The transceiver 3530 provides a means for communicating with various other apparatuses over a transmission medium. The transceiver 3530 receives a signal from the one or more antennas 3535, extracts information from the received signal, and provides the extracted information to the processing system 3510, specifically the reception component 3402. In addition, the transceiver 3530 receives information from the processing system 3510, specifically the transmission component 3404, and generates a signal to be applied to the one or more antennas 3535 based at least in part on the received information.

The processing system 3510 includes one or more processors 3520 coupled to a computer-readable medium/memory 3525. A processor 3520 is responsible for general processing, including the execution of software stored on the computer-readable medium/memory 3525. The software, when executed by the processor 3520, causes the processing system 3510 to perform the various functions described herein for any particular apparatus. The computer-readable medium/memory 3525 may also be used for storing data that is manipulated by the processor 3520 when executing software. The processing system further includes at least one of the illustrated components. The components may be software modules running in the processor 3520, resident/stored in the computer readable medium/memory 3525, one or more hardware modules coupled to the processor 3520, or some combination thereof.

In some aspects, the processing system 3510 may be a component of the core network node 130 and may include one or more memories, such as the memory 292, and/or may include one or more processors, such as the controller/processor 290. In some aspects, the apparatus 3505 for wireless communication includes means for receiving, from a first network entity, service selection information associated with a service; and means for transmitting, to the first network entity, a service identifier associated with the service. The aforementioned means may be one or more of the aforementioned components of the apparatus 3400 and/or the processing system 3510 of the apparatus 3505 configured to perform the functions recited by the aforementioned means. As described elsewhere herein, the processing system 3510 may include the controller/processor 290. In one configuration, the aforementioned means may be the controller/processor 290 configured to perform the functions and/or operations recited herein.

FIG. 35 is provided as an example. Other examples may differ from what is described in connection with FIG. 35.

FIG. 36 is a diagram of an example apparatus 3600 for wireless communication, in accordance with the present disclosure. The apparatus 3600 may be a network entity (e.g., core network node 130, CP service 2120), or a network entity may include the apparatus 3600. In some aspects, the apparatus 3600 includes a reception component 3602 and a transmission component 3604, which may be in communication with one another (for example, via one or more buses and/or one or more other components). As shown, the apparatus 3600 may communicate with another apparatus 3606 (such as a UE, a base station, or another wireless communication device) using the reception component 3602 and the transmission component 3604. As further shown, the apparatus 3600 may include the communication manager 160. The communication manager 160 may include a service component 3608, among other examples.

In some aspects, the apparatus 3600 may be configured to perform one or more operations described herein in connection with FIGS. 1-25. Additionally, or alternatively, the apparatus 3600 may be configured to perform one or more processes described herein, such as method 2900 of FIG. 29. In some aspects, the apparatus 3600 and/or one or more components shown in FIG. 36 may include one or more components of the network entity described in connection with FIG. 2. Additionally, or alternatively, one or more components shown in FIG. 36 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 3602 may receive communications, such as reference signals, control information, data communications, or a combination thereof, from the apparatus 3606. The reception component 3602 may provide received communications to one or more other components of the apparatus 3600. In some aspects, the reception component 3602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 3600. In some aspects, the reception component 3602 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 3604 may transmit communications, such as reference signals, control information, data communications, or a combination thereof, to the apparatus 3606. In some aspects, one or more other components of the apparatus 3600 may generate communications and may provide the generated communications to the transmission component 3604 for transmission to the apparatus 3606. In some aspects, the transmission component 3604 may perform signal processing on the generated communications (such as filtering, amplification, modulation, digital-to-analog conversion, multiplexing, interleaving, mapping, or encoding, among other examples), and may transmit the processed signals to the apparatus 3606. In some aspects, the transmission component 3604 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 3604 may be co-located with the reception component 3602 in one or more transceivers.

The reception component 3602 may receive a message that includes an indication of a service provided over a control plane and a UE ID for the UE. The transmission component 3604 may transmit a configuration for the service. The transmission component 3604 and the service component 3608 may transmit one or more PDUs associated with use of the service over the control plane.

The number and arrangement of components shown in FIG. 36 are provided as an example. In practice, there may be additional components, fewer components, different components, or differently arranged components than those shown in FIG. 36. Furthermore, two or more components shown in FIG. 36 may be implemented within a single component, or a single component shown in FIG. 36 may be implemented as multiple, distributed components. Additionally, or alternatively, a set of (one or more) components shown in FIG. 36 may perform one or more functions described as being performed by another set of components shown in FIG. 36.

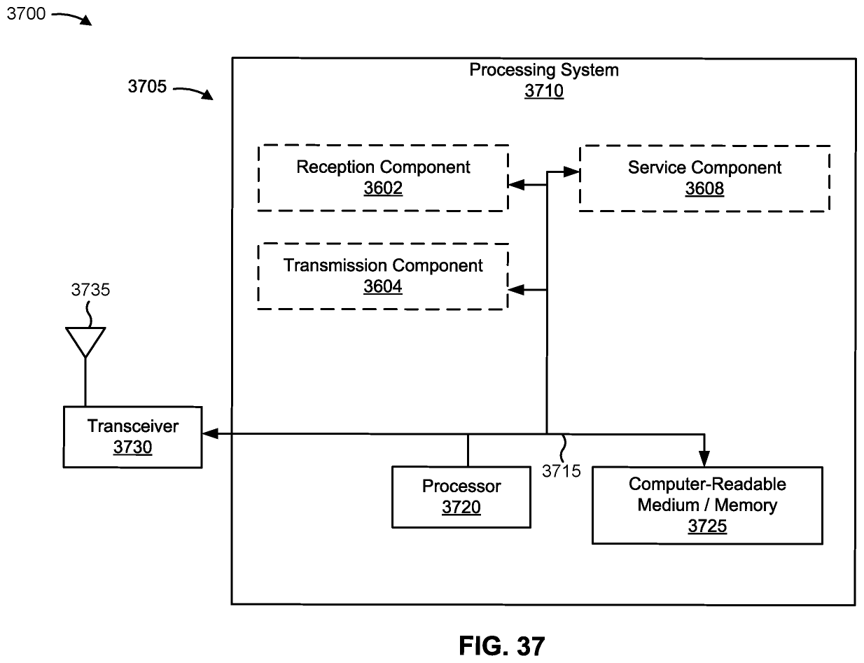

FIG. 37 is a diagram illustrating an example 3700 of a hardware implementation for an apparatus 3705 employing a processing system 3710, in accordance with the present disclosure. The apparatus 3705 may be a network entity or may be at (e.g., included in) a network entity.

The processing system 3710 may be implemented with a bus architecture, represented generally by the bus 3715. The bus 3715 may include any number of interconnecting buses and bridges depending on the specific application of the processing system 3710 and the overall design constraints. The bus 3715 links together various circuits including one or more processors and/or hardware components, represented by the processor 3720, the illustrated components, and the computer-readable medium/memory 3725. The bus 3715 may also link various other circuits, such as timing sources, peripherals, voltage regulators, and/or power management circuits.

The processing system 3710 may be coupled to one or more transceivers 3730. A transceiver 3730 is coupled to one or more antennas 3735. The transceiver 3730 provides a means for communicating with various other apparatuses over a transmission medium. The transceiver 3730 receives a signal from the one or more antennas 3735, extracts information from the received signal, and provides the extracted information to the processing system 3710, specifically the reception component 3602. In addition, the transceiver 3730 receives information from the processing system 3710, specifically the transmission component 3604, and generates a signal to be applied to the one or more antennas 3735 based at least in part on the received information.

The processing system 3710 includes one or more processors 3720 coupled to a computer-readable medium/memory 3725. A processor 3720 is responsible for general processing, including the execution of software stored on the computer-readable medium/memory 3725. The software, when executed by the processor 3720, causes the processing system 3710 to perform the various functions described herein for any particular apparatus. The computer-readable medium/memory 3725 may also be used for storing data that is manipulated by the processor 3720 when executing software. The processing system further includes at least one of the illustrated components. The components may be software modules running in the processor 3720, resident/stored in the computer readable medium/memory 3725, one or more hardware modules coupled to the processor 3720, or some combination thereof.

In some aspects, the processing system 3710 may be a component of the core network node 130 and may include one or more memories, such as the memory 292, and/or may include one or more processors, such as the controller/processor 290. In some aspects, the apparatus 3705 for wireless communication includes means for receiving a message that includes an indication of a service provided over a control plane and an identifier for another apparatus; and means for transmitting a configuration for the service. The aforementioned means may be one or more of the aforementioned components of the apparatus 3600 and/or the processing system 3710 of the apparatus 3705 configured to perform the functions recited by the aforementioned means. As described elsewhere herein, the processing system 3710 may include the controller/processor 290. In one configuration, the aforementioned means may be the controller/processor 290 configured to perform the functions and/or operations recited herein.

FIG. 37 is provided as an example. Other examples may differ from what is described in connection with FIG. 37.

The following provides an overview of some Aspects of the present disclosure:

Aspect 1: A method of wireless communication performed by a user equipment (UE), comprising: selecting a service provided over a control plane; transmitting a message that includes an indication of the service and a UE identifier (ID) for the UE; and receiving a configuration for the service.

Aspect 2: The method of Aspect 1, wherein the message includes a first protocol data unit (PDU) with a control plane transport header that includes the indication of the service and the UE ID.

Aspect 3: The method of Aspect 2, wherein the control plane transport header is associated with a control plane transport protocol layer, and wherein the first PDU is a service PDU associated with a service PDU protocol layer.

Aspect 4: The method of Aspect 3, further comprising establishing security for the UE using a security service with messaging on a security protocol layer between the control plane transport protocol layer and the service PDU protocol layer.

Aspect 5: The method of Aspect 4, wherein establishing security for the UE includes selecting an authentication and security service, and wherein the indication of the service indicates the authentication and security service.

Aspect 6: The method of Aspect 2, wherein the first protocol data unit (PDU) includes a non-access stratum (NAS) PDU.

Aspect 7: The method of any of Aspects 1-6, wherein the indication of the service includes a service ID.

Aspect 8: The method of any of Aspects 1-7, wherein the indication of the service includes service selection information associated with a service ID.

Aspect 9: The method of Aspect 8, wherein the service selection information includes a service selection ID.

Aspect 10: The method of any of Aspects 1-9, further comprising transmitting one or more protocol data units (PDUs) associated with use of the service over the control plane.

Aspect 11: The method of any of Aspects 1-10, further comprising obtaining a service ID for a discovery and selection service that indicates available services on the control plane.

Aspect 12: The method of Aspect 11, wherein obtaining the service ID for the discovery and selection service includes receiving the service ID in system information or via a configuration.

Aspect 13: The method of Aspect 11, wherein obtaining the service ID for the discovery and selection service includes obtaining a preconfigured service ID.

Aspect 14: The method of any of Aspects 1-13, further comprising receiving a service module ID for a service module associated with the service.

Aspect 15: The method of any of Aspects 1-14, wherein the service is an access and mobility service over the control plane.

Aspect 16: The method of any of Aspects 1-14, wherein the service is a data service over the control plane.

Aspect 17: The method of any of Aspects 1-14, wherein the service is a subscription service or a policy service over the control plane.

Aspect 18: The method of any of Aspects 1-14, wherein the service is a network exposure function over the control plane.

Aspect 19: A method of wireless communication performed by a first network entity, comprising: receiving, from a user equipment (UE), a message that includes an indication of a service provided over a control plane and a UE identifier (ID) for the UE; and forwarding the message to an address for the service based at least in part on the indication of the service.

Aspect 20: The method of Aspect 19, wherein the address is an internet protocol address.

Aspect 21: The method of any of Aspects 19-20, wherein forwarding the message includes forwarding the message using tunneling over one or more of a hypertext transport protocol, a transport control protocol, an internet protocol, a user datagram protocol, or a quick user datagram protocol internet connection.

Aspect 22: The method of any of Aspects 19-21, further comprising mapping the address to the service.

Aspect 23: The method of any of Aspects 19-22, further comprising transmitting a configuration for the service to the UE.

Aspect 24: The method of any of Aspects 19-23, wherein the message includes a first protocol data unit (PDU) with a control plane transport header that includes the indication of the service and the UE ID.

Aspect 25: The method of any of Aspects 19-24, wherein the indication of the service includes service selection information associated with a service ID, and wherein the method includes: transmitting the service selection information with a request for the service ID to a second network entity of a discovery and selection service; and receiving one or more of the address for the service or the service ID.

Aspect 26: The method of Aspect 25, wherein the address is associated with the service ID.

Aspect 27: The method of Aspect 25, further comprising transmitting the service ID to the UE.

Aspect 28: The method of any of Aspects 19-27, wherein the indication of the service includes a service selection ID, wherein the message includes a non-access stratum (NAS) protocol data unit (PDU), and wherein the method includes: selecting a service exposure and orchestration function (SEOF) using the service selection ID; and forwarding the NAS PDU to the SEOF.

Aspect 29: A method of wireless communication performed by a second network entity, comprising: receiving, from a first network entity, service selection information associated with a service; and transmitting, to the first network entity, a service identifier (ID) associated with the service.

Aspect 30: The method of Aspect 29, further comprising transmitting, to the first network entity, an address for the service or a service profile for the service.

Aspect 31: The method of Aspect 30, wherein the service profile is for a discovery and selection service or an authentication and security service.

Aspect 32: The method of any of Aspects 29-31, further comprising: performing a security check for a user equipment (UE); and receiving subscription information for the service.

Aspect 33: A method of wireless communication performed by a network entity, comprising: receiving a message that includes an indication of a service provided over a control plane and a user equipment (UE) identifier (ID) for the UE; and transmitting a configuration for the service.

Aspect 34: The method of Aspect 33, further comprising transmitting one or more protocol data units (PDUs) associated with use of the service over the control plane.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories, the one or more processors individually or collectively configured to cause the UE to:
select a service provided over a control plane;
transmit a message that includes an indication of the service and a UE identifier (ID) for the UE; and
receive a configuration for the service.

2. The apparatus of claim 1, wherein the message includes a first protocol data unit (PDU) with a control plane transport header that includes the indication of the service and the UE ID.

3. The apparatus of claim 2, wherein the control plane transport header is associated with a control plane transport protocol layer, and wherein the first PDU is a service PDU associated with a service PDU protocol layer.

4. The apparatus of claim 3, wherein the one or more processors are individually or collectively configured to cause the UE to establish security for the UE using a security service with messaging on a security protocol layer between the control plane transport protocol layer and the service PDU protocol layer.

5. The apparatus of claim 4, wherein to establish security for the UE, the one or more processors are individually or collectively configured to cause the UE to select an authentication and security service, and wherein the indication of the service indicates the authentication and security service.

6. The apparatus of claim 5, wherein the first protocol data unit (PDU) includes a non-access stratum (NAS) PDU.

7. The apparatus of claim 1, wherein the indication of the service includes a service ID.

8. The apparatus of claim 1, wherein the one or more processors are individually or collectively configured to cause the UE to service selection information associated with a service ID.

9. The apparatus of claim 8, wherein the service selection information includes a service selection ID.

10. The apparatus of claim 1, wherein the one or more processors are individually or collectively configured to cause the UE to transmit one or more protocol data units (PDUs) associated with use of the service over the control plane.

11. The apparatus of claim 1, wherein the one or more processors are individually or collectively configured to cause the UE to obtain a service ID for a discovery and selection service that indicates available services on the control plane.

12. The apparatus of claim 11, wherein to obtain the service ID for the discovery and selection service, the one or more processors are individually or collectively configured to cause the UE to receive the service ID in system information or via a configuration.

13. The apparatus of claim 11, wherein to obtain the service ID for the discovery and selection service, the one or more processors are individually or collectively configured to cause the UE to obtain a preconfigured service ID.

14. The apparatus of claim 1, wherein the one or more processors are individually or collectively configured to cause the UE to receive a service module ID for a service module associated with the service.

15. The apparatus of claim 1, wherein the service is an access and mobility service over the control plane.

16. The apparatus of claim 1, wherein the service is a data service over the control plane.

17. The apparatus of claim 1, wherein the service is a subscription service, a policy service over the control plane, or a network exposure function over the control plane.

18. An apparatus for wireless communication at a first network entity, comprising:
one or more memories; and
one or more processors coupled to the one or more memories, the one or more processors individually or collectively configured to cause the first network entity to:
receive, from a user equipment (UE), a message that includes an indication of a service provided over a control plane and a UE identifier (ID) for the UE; and
forward the message to an address for the service based at least in part on the indication of the service.

19. The apparatus of claim 18, wherein the one or more processors are individually or collectively configured to cause the first network entity to map the address to the service.

20. The apparatus of claim 18, wherein the one or more processors are individually or collectively configured to cause the first network entity to transmit a configuration for the service to the UE.

21. The apparatus of claim 18, wherein the message includes a first protocol data unit (PDU) with a control plane transport header that includes the indication of the service and the UE ID.

22. The apparatus of claim 18, wherein the indication of the service includes service selection information associated with a service ID, and wherein the one or more processors are individually or collectively configured to cause the first network entity to:
transmit the service selection information with a request for the service ID to a second network entity of a discovery and selection service; and
receive one or more of the address for the service or the service ID.

23. The apparatus of claim 22, wherein the one or more processors are individually or collectively configured to cause the first network entity to transmit the service ID to the UE.

24. The apparatus of claim 18, wherein the indication of the service includes a service selection ID, wherein the message includes a non-access stratum (NAS) protocol data unit (PDU), and wherein the one or more processors are individually or collectively configured to cause the first network entity to:
select a service exposure and orchestration function (SEOF) using the service selection ID; and
forward the NAS PDU to the SEOF.

25. An apparatus for wireless communication at a second network entity, comprising:
one or more memories; and
one or more processors coupled to the one or more memories, the one or more processors individually or collectively configured to cause the second network entity to:
receive, from a first network entity, service selection information associated with a service; and
transmit, to the first network entity, a service identifier (ID) associated with the service.

26. The apparatus of claim 25, wherein the one or more processors are individually or collectively configured to cause the first network entity to transmit, to the first network entity, an address for the service or a service profile for the service.

27. The apparatus of claim 26, wherein the service profile is for a discovery and selection service or an authentication and security service.

28. The apparatus of claim 25, wherein the one or more processors are individually or collectively configured to cause the first network entity to:
perform a security check for a user equipment (UE); and
receive subscription information for the service.

29. An apparatus for wireless communication at a network entity, comprising:
one or more memories; and
one or more processors coupled to the one or more memories, the one or more processors individually or collectively configured to cause the network entity to:
receive a message that includes an indication of a service provided over a control plane and a user equipment (UE) identifier (ID) for a UE; and
transmit a configuration for the service.

30. The apparatus of claim 29, wherein the one or more processors are individually or collectively configured to cause the network entity to transmit one or more protocol data units (PDUs) associated with use of the service over the control plane.
